(19) United States
(12) Patent Application Publication
(10) Pub. No.: US 2019/0105861 A1
(43) Pub. Date: Apr. 11, 2019

(54) Retread Band and Retread Rim Assembly Comprising Said Band

(71) Applicant: Firestone Industrial Products Company, LLC, Nashville, TN (US)

(72) Inventors: Brandon J. Ward, Brownsburg, IN (US); Jason B. Smith, Fairview, TN (US)

(21) Appl. No.: 15/999,257

(22) PCT Filed: Feb. 16, 2017
(86) PCT No.: PCT/US2017/018241

§ 371 Date: Aug. 17, 2018

Related U.S. Application Data
(60) Provisional application No. 62/452,984, filed on Jan. 31, 2017.
(60) Provisional application No. 62/296,327, filed on Feb. 17, 2016.

(51) Int. Cl. B29D 30/54

(52) U.S. Cl. CPC B29D 30/54; B29D 2030/549

(57) ABSTRACT

Retread rim assemblies (122, 600, 700, 800) include a plurality of rim segments (124, 602, 702, 802) disposed in a generally circular arrangement about a central axis (AX). A retread band (126, 300, 400, 604, 704, 804) extends around the plurality of rim segments such that the retread band is circumferentially tensioned to bias the plurality of rim segments radially inward. The retread band is at least partially formed from an elastomeric material. The retread band can include at least one reinforcing ply (318, 426, 428, 636, 638, 744, 746, 844, 846) embedded in the elastomeric material. Additionally, or in the alternative, the retread band can include an annular rib portion (412, 412′, 630, 734, 834) projecting radially inward and/or outward from along a base portion (410, 410′, 628, 732, 8320. Retread bands (126, 300, 400, 604, 704, 804) and methods of manufacturing retread rim assemblies are also included.

### BACKGROUND

The subject matter of the present disclosure broadly relates to the art of elastomeric articles and, more particularly, to elastomeric bands dimensioned for use with rim assemblies used in connection tire retreading processes. Retread rim assemblies including such elastomeric bands and methods of assembly are also included.

Tires are well known and commonly used on in a wide variety of applications. As one example, known constructions can include airless or so-called “solid” tires that are commonly used in applications in which particularly heavy loads and/or over terrain that includes debris and/or other ground hazards. As another example, known constructions include pneumatic or so-called “tubeless” tires that are commonly used on vehicles that travel over roadways and other surfaces in a wide variety of conditions. The subject matter of the present disclosure may find particular application and use in conjunction with pneumatic tires, and will be shown and described herein with reference thereto. However, it is to be appreciated that the subject matter of the present disclosure is also amenable to use in other applications and environments, and that the specific uses shown and described herein are merely exemplary. For example, the subject matter of the present disclosure could be used in connection with airless tires. Accordingly, the subject matter of the present disclosure is not intended to be limited to uses associated with the retreading of pneumatic tires, which uses are merely exemplary.

Tires of most types commonly include a tread formed along the outer periphery thereof, such as may assist in improving traction, handling and/or other performance characteristics of the tires during such use. In some cases, the tread area of tires can be sufficiently worn away that traction, handling and/or other performance characteristics may be diminished to an undesirable level. In some situations, however, the remainder of the tire, which is often referred to as a carcass, may still be in good condition and capable of undergoing considerably more use. Recognizing that in many cases it may be economical to refurbish and reuse the worn tires, a retreading industry has developed in which usable carcasses are reconditioned and a new tread is applied.

The retread industry has developed numerous processes and corresponding machines and/or equipment to perform retreading processes. In addition to various inspection and reconditioning steps that are performed, retreading processes include removing the remaining original tread layer from the tire carcass. This step is often referred to as a buffing or grinding operation. Retreading processes also include applying one or more layers of uncured rubber material over the buffed surface of the tire carcass. This uncured rubber material is sometimes referred to as a cushion layer, and can be useful to help adhere the new tread layer to the tire carcass and to generate the desired size of a buffed tire carcass for receiving the new tread layer. Additionally, retreading processes include applying a tread layer around the outer periphery of the tire carcass. In many cases, a length of uncured tread material is applied over the uncured rubber layer with the ends joined to form an endless tire tread around the outer circumference of the tire. Finally, retreading processes include curing the uncured layers of rubber, tread and other materials.

One aspect of retreading processes that has been identified as contributing to the overall quality of retread tires is the concentricity of the tread to the original tire casing. Rim assemblies of a variety of type and kinds have been developed to receive and concentrically support the original tire casing. In some cases, the rim assemblies are formed from two side sections that are positioned along opposing sides of the tire casing. The side sections engage the bead areas of the original tire casing in a manner suitable for forming a substantially fluid-tight seal therewith. In other cases, expandable rim assemblies are formed from numerous rim segments that fit together in a somewhat pie-shaped arrangement. The rim segments fit through the center of the original tire casing in a collapsed condition and can then be expanded to engage the bead areas of the original tire casing in a substantially fluid-tight manner. In these and other constructions, the resulting hub or rim is used to support the original casing during various retreading processes, such as during buffing processes as well as cushion and tread application processes.

As mentioned above, expandable rim assemblies include multiple rim segments that are positioned adjacent one another in a generally circular arrangement. In some cases, an elastomeric band extends peripherally around the rim segments and urges the rim segments in a radially inward direction. Such elastomeric bands are capable of stretching as the rim segments are displaced radially into an expanded condition. Typically, conventional elastomeric bands used in such applications have a generally flat cross-sectional shape to aid in the ingress and egress of the rim assemblies into and out of the tire casing. Additionally, conventional elastomeric bands are formed from unreinforced elastomeric material. As a result of repeated expansion and recovery during use, conventional elastomeric bands undergo an inelastic stretching that results in the elastomeric band becoming loose along the rim segments. Under such conditions, adjacent rim segments can become disarranged relative to one another, which can render the expandable rim assembly difficult to work with thereby reducing the efficiency of retreading processes. In some cases, the elastomeric bands can become so loose and the rim segments sufficiently disarranged that the rim assembly may be deemed unusable without replacement of the elastomeric band. It is well understood that the removal of such rim assemblies from the production environment for repair can contribute to increase costs associated with the production of retread tires.

In some cases, a secondary elastomeric band can be installed over top of the original elastomeric band. Often, the secondary elastomeric band can provide sufficient additional radial bias to original elastomeric band to maintain the rim segments in position for an additional duration prior to requiring replacement of the primary elastomeric band. However, conventional secondary elastomeric bands have a cross-sectional shape or profile that can reduce the ease with which tire casings can be engaged and disengaged with rim assemblies.

In view of the foregoing and notwithstanding the overall success of conventional elastomeric bands for retread rim assemblies, it is believed that the foregoing and/or other disadvantages of conventional constructions exist and that a need remains to meet the aforementioned competing goals while still retaining comparable or improved performance and other desired features. Accordingly, it is believed desirable to develop constructions and method of manufacture that overcome the foregoing and/or other problems and/or disadvantages of known designs, and/or otherwise advance the art of elastomeric articles.

### BRIEF SUMMARY

One example of a retread rim assembly in accordance with the subject matter of the present disclosure is dimensioned to receive an associated tire having associated tire beads. The retread rim assembly can include a plurality of rim segments disposed in a generally circular arrangement about a central axis. The plurality of rim segments can include a segment body extending radially between an inner end and an outer periphery disposed radially outward of the inner end. The segment body can also include a first end surface and a second end surface oriented at an acute angle relative to the first end surface. The segment body can further include a first edge wall disposed along the outer periphery, a second edge wall spaced axially from the first edge wall along the outer periphery and a base surface extending axially between the first and second edge walls with the base surface and the first and second edge walls extending arcuately between the first and second end surfaces. A retread band can be at least partially formed from an elastomeric material. The retread band can extend lengthwise from a first edge to a second edge spaced axially from the first edge. And, the retread band can extend peripherally about the central axis such that a midplane is disposed between the first and second edges with the midplane being oriented transverse to the central axis. The retread band can have an inner surface facing radially inward and an outer surface facing radially outward. The retread band can be disposed around the plurality of rim segments such that the inner surface is disposed in abutting engagement with the base surfaces of the plurality of rim segments. The retread band can be circumferentially tensioned to bias the plurality of rim segments radially inward such that adjacent rim segments are disposed in abutting engagement with one another along the first and second end surfaces.

In some cases, a retread band as described in the foregoing paragraph can include at least one reinforcing ply at least partially embedded within the elastomeric material of the retread band. The at least one reinforcing ply can extend circumferentially within the elastomeric material and lengthwise between the first and second edges of the retread band.

In some cases, a retread band as described in either of the two foregoing paragraphs can have a cross-sectional shape with a base portion and a rib portion that projects outward beyond the base portion. In some cases, the rib portion can be disposed radially outward of the base portion. In other cases, the rib portion can be disposed radially inward of the base portion. In such other cases, the base surface of the segment body of the plurality of rim segments can, optionally, include a base surface portion and at least one groove surface portion that at least partially defines at least one segment body channel dimensioned to receive at least a portion of a rib portion of a retread band as described in this paragraph or either of the two foregoing paragraphs.

One example of a retread rim band in accordance with the subject matter of the present disclosure can be elastically extensible about an associated plurality of retread rim segments. The retread band can include first layer of elastomeric material extending annularly about a longitudinal axis. The retread band can also include a first annular edge and a second annular edge that is spaced longitudinally from the first annular edge. An inner surface can face radially inward and can be dimensioned to abuttingly engage the associated plurality of retread rim segments. An outer surface can face radially outward and can be dimensioned to abuttingly engage associated beads of an associated tire to be retreaded. At least one reinforcing ply can be embedded within the first layer of elastomeric material. The at least one reinforcing ply can extend annularly within the first layer of elastomeric material about the longitudinal axis.

Another example of a retread rim band in accordance with the subject matter of the present disclosure can be elastically extensible about an associated plurality of retread rim segments. The retread band can have a longitudinal axis and can include a first annular edge and a second annular edge spaced longitudinally from the first annular edge. An inner surface can face radially inward and can be dimensioned to abuttingly engage the associated plurality of retread rim segments. An outer surface can face radially outward and can be dimensioned to abuttingly engage associated beads of an associated tire to be retreaded. The retread band can be at least partially formed from an elastomeric material that extends annularly about the longitudinal axis. The retread band can include a cross-sectional shape with a base portion and a rib portion projecting from the base portion in a radial direction. The base portion can extend longitudinally from the first annular edge to the second annular edge and having a base height extending from at least a portion of the inner surface to at least a portion of the outer surface. The rib portion can extend in a radial direction from along a portion of one of the inner and outer surfaces to a rib surface portion spaced in a radial direction from along the one of the inner and outer surfaces. The rib portion can extend longitudinally between a first rib edge spaced longitudinally inward from the first annular edge and a second rib edge spaced longitudinally inward from the second annular edge. In some cases, a retread band according to this paragraph can include a rib portion disposed radially outward of the base portion. In other cases, a retread band according to this paragraph can include a rib portion disposed radially inward of the base portion.

A further example of a retread rim band in accordance with the subject matter of the present disclosure can be elastically extensible about an associated plurality of retread rim segments. The rim segments include one or more channels extending radially inward toward an inner end of the rim segment. The one or more segment channels can extend longitudinally between a first channel edge and a second channel edge. The associated retread band can have a longitudinal axis and can include an inner surface facing radially inward. One or more rib portions can extend radially inward from the inner surface and can be dimensioned to abuttingly engage at least a portion of the associated rim segment channels. An outer surface of the retread band can face radially outward and can be dimensioned to abuttingly engage associated beads of an associated tire to be retreaded. The retread band can be at least partially formed from an elastomeric material that extends annularly about the longitudinal axis. The retread band can include a cross-sectional shape with a base portion and at least one rib portion projecting radially inward from the base portion. The base portion can extend longitudinally from the first annular edge to the second annular edge and can have a base height extending from the outer surface to at least one base surface portion of the inner surface. The at least one rib portion can extend radially inward from along the at least one base surface portion of the inner surface to a rib surface portion of the inner surface spaced radially inward of the at least one base surface portion. The at least one rib portion can extend longitudinally between a first rib edge spaced longitudinally inward from the first annular edge and a second rib edge spaced longitudinally inward from the second annular edge.

One example of a method of assembling a retread rim assembly in accordance with the subject matter of the present disclosure can include providing a plurality of rim segments. The plurality of rim segments can include a segment body extending radially between an inner end and an outer periphery disposed radially outward of the inner end. The segment body can include a first end surface and a second end surface oriented at an acute angle relative to the first end surface. And, the segment body can include a first edge wall disposed along the outer periphery, a second edge wall spaced axially from the first edge wall along the outer periphery and a base surface extending axially between the first and second edge walls with the base surface and the first and second edge walls extending arcuately between the first and second end surfaces. The method can also include providing a retread band according to either of the foregoing paragraphs. The method can further include positioning the plurality of rim segments in a generally circular arrangement about a central axis with the retread band disposed around the plurality of rim segments such that the inner surface of the retread band is disposed in abutting engagement with the base surfaces of the plurality of rim segments and such that the retread band is circumferentially tensioned to bias the plurality of rim segments radially inward such that adjacent rim segments are disposed in abutting engagement with one another along the first and second end surfaces thereof.

### BRIEF DESCRIPTION OF THE DRAWINGS

FIG. 1 is a schematic representation of one example of a tire retreading machine shown in use with a retread rim assembly in accordance with the subject matter of the present disclosure.

FIG. 2 is a side view of one example of a retread rim assembly in accordance with the subject matter of the present disclosure shown in use with an associated tire in condition for retreading.

FIG. 3 a greatly enlarged view of the portion of the retread rim assembly and associated tire identified as Detail 3 in FIG. 2.

FIG. 4 is a side view of the retread rim assembly in FIGS. 1-3 shown in an unexpanded condition prior to engagement with an associated tire.

FIG. 5 is a cross-sectional side view of the retread rim assembly and associated tire in FIGS. 1-3 taken from along line 5-5 in FIG. 2.

FIG. 6 an enlarged view of the portion of the retread rim assembly and associated tire in FIGS. 1-5 identified as Detail 6 in FIG. 5.

FIG. 7 is a top perspective view of one example of a retread band in accordance with the subject matter of the present disclosure.

FIG. 8 is a side view of the exemplary retread band in FIG. 7.

FIG. 9 is a cross-sectional side view of the exemplary retread band in FIGS. 7 and 8 taken from along line 9-9 in FIG. 8.

FIG. 10 is a greatly enlarged view of the portion of the exemplary retread band in FIGS. 7-9 identified as Detail 10 in FIG. 9.

FIG. 11 is a top perspective view of another example of a retread band in accordance with the subject matter of the present disclosure.

FIG. 12 is a side view of the exemplary retread band in FIG. 11.

FIG. 13 is a cross-sectional side view of the exemplary retread band in FIGS. 11 and 12 taken from along line 13-13 in FIG. 12.

FIG. 14 is a greatly enlarged view of the portion of the exemplary retread band in FIGS. 11-13 identified as Detail 14 in FIG. 13.

FIG. 15 is a greatly enlarged view, similar to the view of FIG. 14, of an alternate construction the exemplary retread band shown in FIGS. 11-14.

FIG. 16 is a cross-sectional side view of a second example of a retread rim assembly and associated tire in accordance with the subject matter of the present disclosure taken from along a line similar to line 5-5 in FIG. 2.

FIG. 17 an enlarged view of the portion of the retread rim assembly and associated tire identified as Detail 17 in FIG. 16.

FIG. 18 is a cross-sectional side view of a third example of a retread rim assembly and associated tire in accordance with the subject matter of the present disclosure taken from along a line similar to line 5-5 in FIG. 2.

FIG. 19 an enlarged view of the portion of the retread rim assembly and associated tire identified as Detail 19 in FIG. 18.

FIG. 20 an enlarged view of a portion of the retread rim assembly and associated tire identified shown in FIG. 19 showing an alternate construction of a retread band in accordance with the subject matter of the present disclosure.

FIG. 21 is a cross-sectional side view of a fourth example of a retread rim assembly and associated tire in accordance with the subject matter of the present disclosure take from along a line similar to line 5-5 in FIG. 2.

FIG. 22 an enlarged view of the portion of the retread rim assembly and associated tire identified as Detail 22 in FIG. 21.

### DETAILED DESCRIPTION

Turning now to the drawings, it is to be understood that the showings are for purposes of illustrating examples of the subject matter of the present disclosure and are not intended to be limiting. Additionally, it will be appreciated that the drawings are not to scale and that portions of certain features and/or elements may be exaggerated for purposes of clarity and/or ease of understanding.

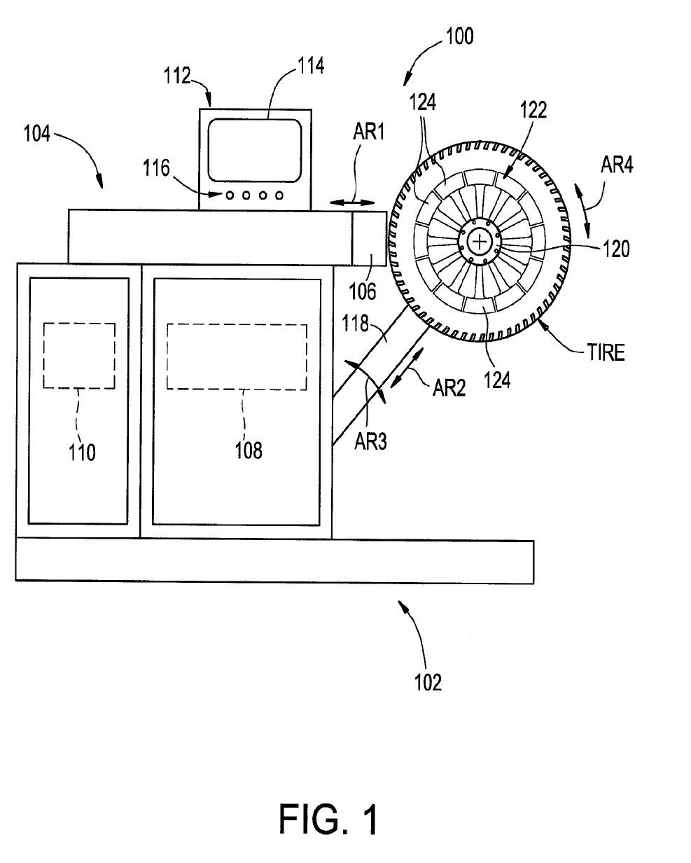

FIG. 1 broadly represents an apparatus or device used in connection with a tire retreading one or more steps of a tire retreading process, and is broadly identified herein as a tire retreading machine 100. It will be appreciated that tire retreading machine 100 in FIG. 1 can be representative of any one or more pieces of conventional equipment used in connection with any one or more known processes or steps of known tire retreading processes, and that the features shown and described herein with regard tire retreading machine 100 are merely exemplary and not intended to be limiting.

Tire retreading machine 100 is shown as including a base 102 that can be supported on a floor or other surface of a suitable facility. A retread processing unit 104 is shown as being supported on base 102 and can include a retread processing head 106 operatively associated therewith. It will be appreciated that retread processing unit 104 and retread processing head 106 can be representative of any system, component and/or device associated with known tire retreading processes. For example and without being limiting, retread processing unit 104 and retread processing head 106 could be representative of an actuator or drive unit and a corresponding buffing head, a rubber extrusion unit and a corresponding rubber application head, and/or a tread forming unit and a corresponding tread application head. As is represented by arrow AR1 in FIG. 1, retread processing head 106 can, in some cases, be displaceable relative to retread processing unit 104, such as may be beneficial for positioning the retread processing head relative to tires of different shapes or sizes, for example.

It will be appreciated that retread processing unit 104, retread processing head 106 as well as a wide variety of other features, components and devices commonly associated with known tire retreading machines can be energized, operated and/or otherwise controlled in any suitable manner and by way of any one or more power sources. For example, one of more features, components and/or devices of the tire retreading machine could be pneumatically and/or electrically operated and/or controlled. As shown in FIG. 1, tire retreading machine 100 can, optionally, include a pressurized gas system 108 that can be operatively associated with one or more features, components, systems and/or devices of the tire retreading machine, such as one or more of retread processing unit 104 and/or retread processing head 106, for example. If provided, pressurized gas system 108 can be operative to generate, supply, exhaust and/or otherwise transfer pressurized gas to and/or from such one or more features, components, systems and/or devices of the tire retreading machine.

Additionally, or in the alternative, tire retreading machine 100 can, optionally, include an electrical control system 110 that can be operatively associated with one or more features, components, systems and/or devices of the tire retreading machine, such as one or more of retread processing unit 104 and/or retread processing head 106, for example. Again, if provided, electrical control system 110 can be operative to generate, receive and/or otherwise communicate electrical signals and/or information to and/or from such one or more features, components, systems and/or devices of the tire retreading machine.

In some cases, tire retreading machine 100 can, optionally, include an operator interface 112. If included, such an operator interface may be suitable for actuating and/or energizing features, components, systems and/or devices of the tire retreading machine; initiating or discontinuing one or more actions, steps and/or processes; and/or communicating information, data and/or signals of any suitable type or kind to an operator and/or receiving input information, communications, data and/or signals of any suitable type or kind from an operator. One example of a suitable operator interface 112 is shown in FIG. 1 as including a display 114. In some cases, display 114 can take the form of a touch-screen display permitting an operator to receive information and input commands and/or other information. Additionally, or in the alternative, operator interface 112 can include a plurality of operator input devices 116 (e.g., buttons and/or switches). It will be appreciated, however, that any other suitable combination of devices, components and/or arrangements can alternately be used.

Conventional tire retreading machines typically include one or more structural components operative to support at least an associated tire that is used, worn or otherwise in condition for retreading. In the arrangement shown in FIG. 1, for example, a support arm 118 extends from along base 102 toward an actuation and support hub 120 that is disposed adjacent retread processing head 106. In some cases, the support arm or other structure can be disposed in a generally fixed position relative to at least the base of the tire retreading machine. In which cases, retread processing head 106 being displaceable, such as has been described above in connection with arrow AR1, for example, may be desirable. In other cases, support arm 118 can extend and retract and/or otherwise articulate, such as are respectively represented in FIG. 1 by extension/retraction arrow AR2 and pivot arrow AR3, for example.

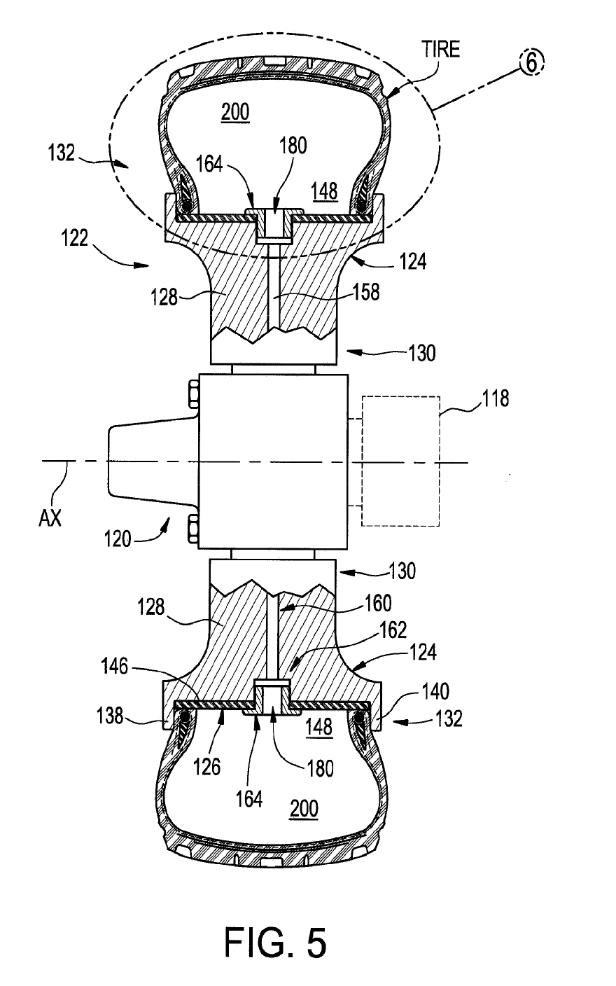

A retread rim assembly 122 is shown in FIGS. 1 and 5 as being supported on support arm 118 such that an associated tire TIRE is disposed adjacent retread processing head 106. It will be appreciated that associated tire TIRE is representative of tires of any suitable type, kind and/or construction that are used, worn or otherwise in condition for retreading or other reconditioning. Retread rim assembly 122 is of a type, kind and construction that is suitable for operative engagement with actuation and support hub 120. The operative connection between hub 120 and retread rim assembly 122 will permit associated tire TIRE to be securely supported on the retread rim assembly and introduced to the retread processing head in a suitable manner for performance of one or more retread steps or processes. In a preferred arrangement, hub 120 and retread rim assembly 122 can be operative to rotate associated tire TIRE relative to retread processing head 106, such as by rotating one or more of hub 120 and retread rim assembly 122 relative to support arm 118, for example, such as is represented in FIG. 1 by arrow AR4.

It will be appreciated that a retread rim assembly in accordance with the subject matter of the present disclosure can be of any type, kind and/or construction operative to engage and secure the associated tire in a manner suitable for rotatably driving the associated tire during an action or processing step performed by retread processing head 106. In such case, the engagement between the retread rim assembly and the associated tire is preferably sufficient to withstand the forces and/or loads applied to the tire during such actions and/or processing steps. Additionally, in a preferred arrangement, a retread rim assembly in accordance with the subject matter of the present disclosure will be capable of forming a substantially fluid-tight seal with the associated tire. Such an arrangement may be beneficial during the retreading of tires of certain types, kinds and/or constructions, such as pneumatic tires, for example. In particular, it is believed that improved quality and/or performance characteristics of retreaded pneumatic tires can be achieved when one or more of the retreading steps and/or processes are completed with the associated pneumatic tire in an at least partially inflated condition. Non-limiting examples of such characteristics can include improved sizing and/or concentricity of the resulting retread tire.

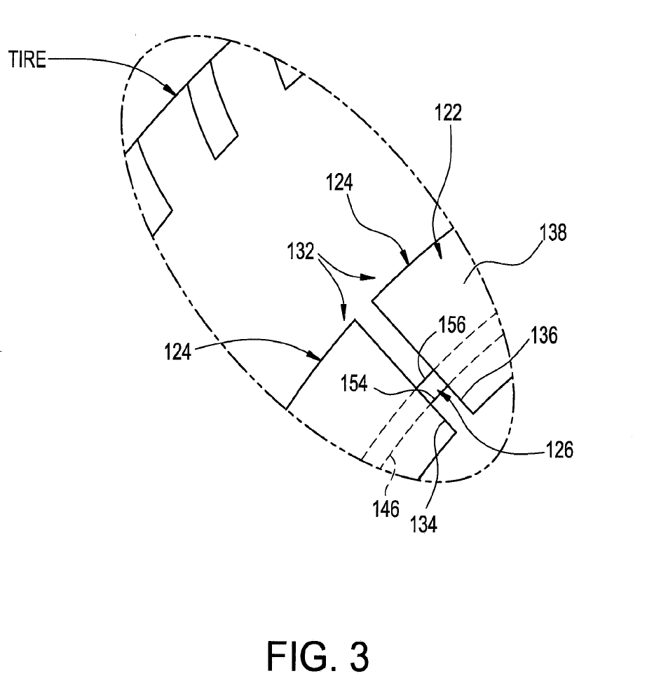

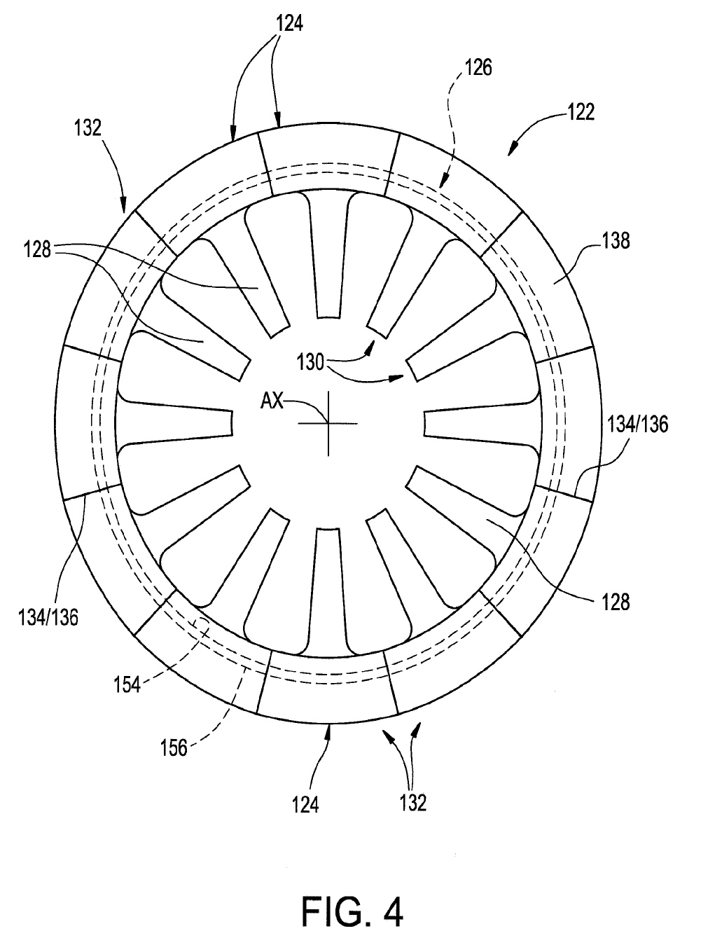

Retread rim assembly 122 represents one example of a retread rim assembly in accordance with the subject matter of the present disclosure. Retread rim assembly 122 is shown in FIGS. 1-6 as having a longitudinal axis AX about which retread rim assembly 122 can rotate in a mounted or otherwise installed condition, such as on or along tire retreading machine 100, for example. Retread rim assembly 122 includes a plurality of rim segments 124 as well as a retread band 126 in accordance with the subject matter of the present disclosure that is operatively engaged with the plurality of rim segments. As shown in FIGS. 1-6, rim segments 124 can be arranged peripherally about longitudinal axis AX. Retread band 126 can extend around rim segments 124 such that the retread band is circumferentially tensioned to bias the plurality of rim segments radially inward such that adjacent rim segments are disposed in abutting engagement with one another in a free, natural or otherwise unexpanded condition of retread rim assembly 122, such as is shown in FIG. 4, for example.

It will be recognized and appreciated that rim segments 124 can be of any suitable size, shape, configuration and/or construction. For example, rim segments 124 can include a segment body 128 that is formed from a suitably strong and rigid material or combination of materials, such as a metal material (e.g., aluminum and/or steel), a polymeric material (e.g., a high-strength reinforced or unreinforced thermoplastic) or any combination thereof. Segment bodies 128 can extend between an inner end 130 and an outer periphery 132, which in an assembled condition of the rim segments is disposed radially outward of inner end 130.

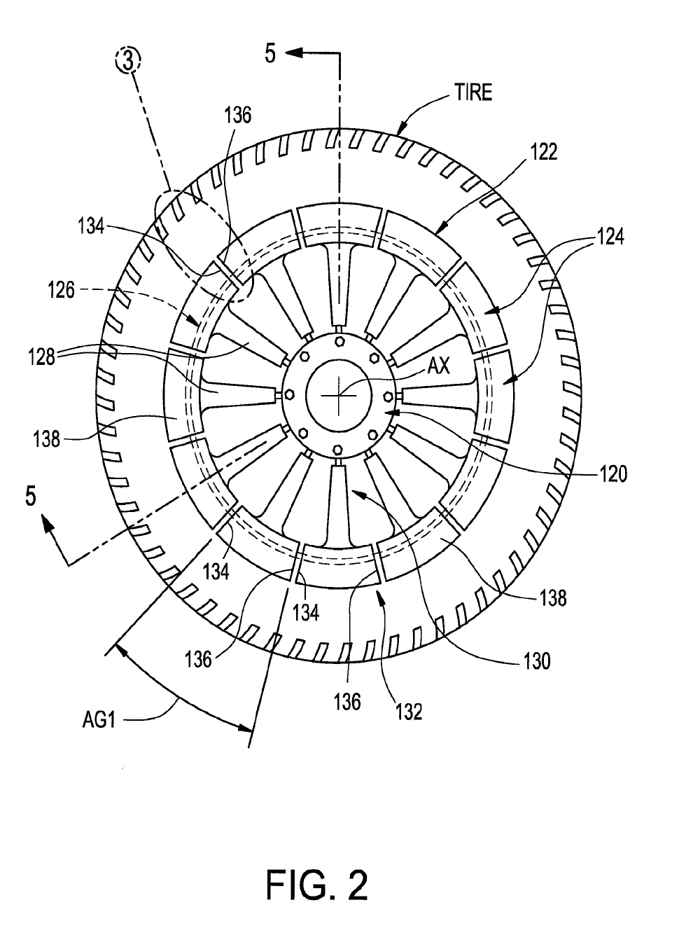

Segment bodies 128 can extend in a direction transverse to longitudinal axis AX between an end surface 134 and an end surface 136 that is spaced apart from end surface 134. In a preferred arrangement, end surfaces 134 and 136 are oriented at an angle relative to one another, such as is represented in FIG. 2 by reference dimension AG1. In a preferred arrangement, retread rim assembly 122 will include between three (3) and thirty (30) rim segments. In one exemplary construction, the angle between end surfaces 134 and 136 can have a value within a range AG_{R} determined by the equation:

$${AG}_{R} ≅ \frac{360}{n} \pm \frac{360}{10 n}$$

where “n” is equal to the number of rim segments from which retread rim assembly 122 is formed. In a preferred arrangement, retread rim assembly 122 can include at least six (6) of rim segments 124 and angle AG1 can have a value within a range of acute angles. It will be appreciated, however, that other configurations and/or arrangements could alternately be used without departing from the subject matter of the present disclosure.

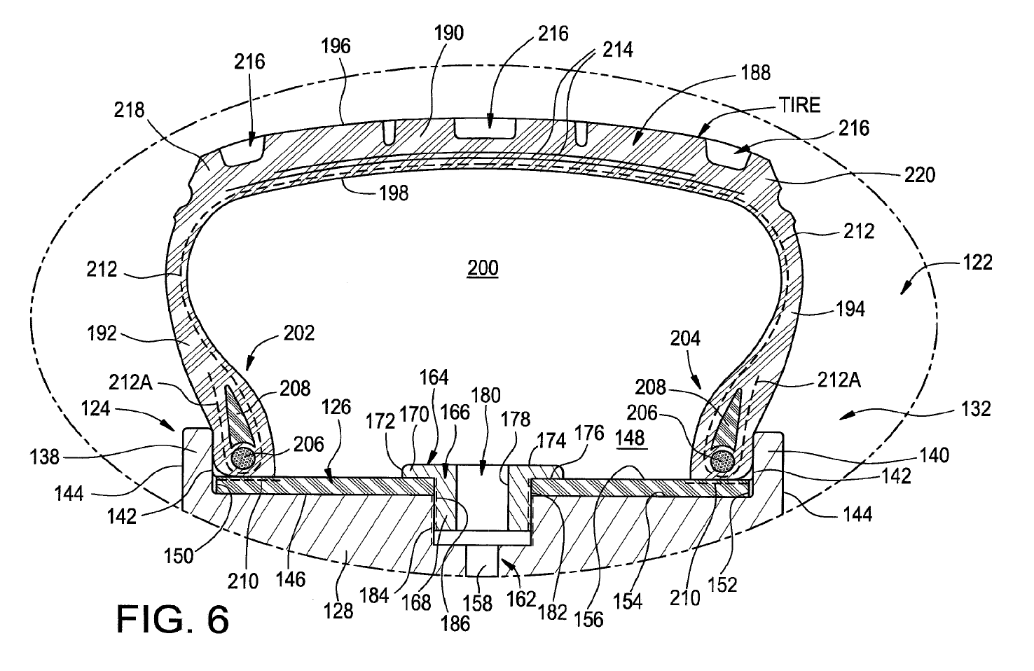

As identified in at least FIGS. 5 and 6, segment bodies 128 can include an edge(or side) wall 138 and an edge (or side) wall 140 that is spaced longitudinally from edge wall 138. Each of edge walls 138 and 140 can include a side surface portion 142 facing toward the other of the edge walls and a side surface portion 144 facing axially outwardly away from the other of the edge walls. Additionally, segment bodies 128 can include a base surface portion 146 that extends axially between edge walls 138 and 140. In a preferred arrangement, edge walls 138 and 140 together with base surface portion 146 extend arcuately between end surfaces 134 and 136. In such case, base surface portions 146 and side surface portions 142 can together at least partially define a rim channel segment 148 extending arcuately along outer periphery 132 of rim segments 124. In an assembled condition of the rim segments, rim channel segments 148 can at least partially define an annular channel (not numbered) extending about longitudinal axis AX and having an open end (not numbered) facing radially outwardly.

Retread band 126 is shown in FIGS. 2-6 as having an outer edge 150 and an outer edge 152 that is space longitudinally from outer edge 150 and defines a band length (not identified) therebetween. Retread band 126 also includes surfaces 154 and 156 that face generally opposite one another and extend axially between outer edges 150 and 152. Surfaces 154 and 156 are spaced apart from one another and at least partially thickness or height (not identified) of the retread band. In an installed condition, retread band 126 extends peripherally around rim segments 124 along and within the annular channel formed by rim channel segments 148. In some cases, retread band 126 can be of a construction that permits installation with either of the surfaces facing radially inward or outward. In a preferred construction, however, retread band 126 can be constructed such that surface 154 functions as an inner surface disposed in facing relation to base surface portions 146 and surface 156 functions as an outer surface facing radially outward from the base surface portions.

In a preferred arrangement, retread band 126 is at least partially formed from one or more elastomeric materials. In such case, the retread band can be circumferentially tensioned around rim segments 124 to bias the plurality of rim segments radially inward such that adjacent rim segments can be disposed in abutting engagement with one another in a free, natural or otherwise unexpanded condition of the retread rim assembly, such as is shown in FIG. 4, for example. In a preferred construction, a retread band in accordance with the subject matter of the present disclosure can include at least one reinforcing ply at least partially embedded within the elastomeric material of the retread band. Additionally, or as an alternately preferred construction, the retread band in accordance with the subject matter of the present disclosure can have a cross-sectional shape with a base portion and a rib portion projecting beyond the base portion in one of a radially-inward direction and a radially-outward direction.

Regardless of which combination of the various features and elements that are included in the construction of a retread band in accordance with the subject matter of the present disclosure, the elastomeric nature of the retread band permits a retread rim assembly in accordance with the subject matter of the present disclosure to be variable between a first condition in which the retread rim assembly has a first outermost radial dimension and a second condition in which the retread rim assembly has a second outermost radial dimension that is greater than the first outermost radial dimension. During use in the first condition, the corresponding first outermost radial dimension is preferably of a size suitable for transitioning an associated tire onto and off of the retread rim assembly. During use in the second condition, the corresponding second outermost radial dimension is preferably of a size suitable for engaging and supporting the associated tire on the retread rim assembly. In a preferred arrangement, the retread rim assembly can be expanded radially outward such that the outer surface of the retread band forms a substantially fluid-tight seal with one or more surfaces or portions of the associated tire.

It will be appreciated that such radially-outward expansion of a retread rim assembly in accordance with the subject matter of the present disclosure can be effectuated in any suitable manner. As one example, actuation and support hub 120 can be operative to support retread rim assembly 122 on support arm 118 or another structure of tire retreading machine 100 for rotation about longitudinal axis AX. Additionally, hub 120 can be operative to engage rim segments 124, and selectively urge or otherwise displace the rim segments in a radially outward direction. In some cases, the actuation and support hub can be electrically actuated. In other cases, the actuation and support hub can urge the rim segments radially outward using pressurized gas or other pneumatic actuation.

In some cases, it may be desirable to provide for the transfer of pressurized gas into and/or out of at least the annular channel formed by rim channel segments 148 of rim segments 124. In cases in which retread rim assembly 122 is used in connection with associated pneumatic or tubeless tires, such as associated tire TIRE, for example, such transfer of pressurized gas can also be operative to inflate and deflate the pneumatic tire. It will be appreciated that any suitable combination of features, components and/or systems can be used to provide for such transfer of pressurized gas. For example, segment body 128 of one or more of rim segments 124 can include a gas transfer passage 158 extending from a passage end 160 disposed along inner end 130 of the segment body to a passage end 162 disposed toward outer periphery 132 of the segment body. In a preferred arrangement, passage end 160 can be disposed in fluid communication with pressurized gas system 108 or another suitable pressurized gas source and/or control device. And, passage end 162 can be disposed in fluid communication along base surface portion 146 of segment body 128.

As shown in FIGS. 5 and 6, a fitting 164 can be disposed in fluid communication between passage end 162 of gas transfer passage 158 and the annular channel formed by rim channel segments 148. In some cases, fitting 164 be constructed in a manner suitable for permitting pressurized gas transfer, as discussed above, as well as for retaining the retread band on or along the rim segment to which the fitting is secured. In a preferred arrangement, a plurality of fittings 164 are used, and can be disposed on or along adjacent ones of the plurality of rim segments. In other cases, the plurality of fittings can be spaced apart from one another with one or more rim segments disposed between adjacent ones of fittings 164.

It will be appreciated that fittings of any suitable type, kind, construction and/or configuration can be used. For example, fitting 164 can include a fitting body 166 formed from a suitable material or combination of materials, such as a metal (e.g., brass, aluminum and/or steel) and/or a polymeric material (e.g., a rigid, reinforced or unreinforced thermoplastic). Fitting body 166 can include a connector wall portion 168, a flange wall portion 170 that extends radially outward from connector wall portion 168 to an outer peripheral edge 172. In an installed condition of fitting 164, flange wall portion 170 can include a surface 174 facing toward the annular channel formed by rim channel segments 148 and a surface 176 facing toward retread band 126. Fitting body 166 can also include a passage surface 178 that at least partially defines a fitting passage 180 extending through fitting body 166. In an installed condition of fitting 164, fitting passage 180 can be disposed in fluid communication with passage end 162 of gas transfer passage 158 and the annular channel formed by rim channel segments 148.

As shown in FIGS. 5 and 6, fitting 164 extends through a hole or opening 182 in retread band 126. It will be appreciated that such holes or openings can be provided in the retread band at the time of manufacture. Or, alternately, such holes or openings can be formed in a suitable manner during the manufacture of retread rim assembly 122. Regardless of the manner in which openings 182 are provided, fitting 164 is shown as extending through the opening in the retread band and being operatively secured on or along rim segments 124. It will be appreciated that the fittings can be attached in any suitable manner. For example, a securement feature 184, such as one or more helical threads, for example, can be formed on or along segment body 128 adjacent passage end 162. A securement feature 186 can be provided on or along fitting body 166 that is cooperative with securement feature 184. For example, one or more helical threads (not numbered) can be provided on or along connector wall portion 168 of the fitting body. In this manner, fittings 164 can be threadably engaged or otherwise secured on or along a corresponding one of rim segments 124. In some cases, fittings 164 can be threadably engaged with the rim segments such that surfaces 176 of flange wall portions 170 are disposed in abutting engagement with surface 156 of retread band 126. It will be appreciated that in an installed condition of a pneumatic or tubeless tire, such as is represented by associated tire TIRE, fitting passage 180 will also be disposed in fluid communication with the tire chamber of the associated pneumatic tire.

For purposes of discussion of operating environment and use, and without operating as a limitation, associated tire TIRE is shown in FIGS. 1-3, 5, 6 and 16-22 as representing one example of an associated tire that is used, worn or otherwise in condition for retreading or other reconditioning. As identified in FIGS. 5 and 6, associated tire TIRE is in the form of a pneumatic tire that extends circumferentially about an axis AX and includes a tire casing 188 that has a crown portion 190 and axially-spaced sidewalls 192 and 194 that extend radially inward from along crown portion 190 The crown portion includes an outer surface 196 and an inner surface 198 that at least partially defines a tire cavity 200.

Associated tire TIRE can also include bead areas 202 and 204 (which, in some cases, may be alternately referred to as “mounting beads” or “mounting bead areas”) that respectively form the radially-inward extent of sidewalls 192 and 194. It will be appreciated that bead areas having a wide variety of combinations of shapes, sizes, features and elements have been developed and can be included on associated tire TIRE without departing from the subject matter of the present disclosure. Non-limiting examples of such features and elements include bead toe features, bead heel features, bead flippers, bead chippers, and chaffing strips. Regardless of the one or more other features and/or elements that may be included on or along the bead areas of the associated tire, the bead areas of can also include at least one bead reinforcing element. In the arrangement in FIGS. 5 and 6, for example, bead areas 202 and 204 of associated tire TIRE are each shown as including bead reinforcing elements in the forms of a bead core 206 and a bead filler 208. Additionally, it will be appreciated that bead areas 202 and 204 are dimensioned or otherwise adapted to form an air-tight relationship along bead seats of a conventional rim or wheel in an installed condition of the original and retreaded tire, as is well understood in the art.

In a preferred arrangement, a retread rim assembly in accordance with the subject matter of the present disclosure is displaceable between the first and second conditions of use. As described above, in the first condition of use, the retread rim assembly has corresponding first radial dimension that is of a size suitable for transferring bead areas 202 and 204 of associated tire TIRE onto and off of the retread rim assembly. And, in the second condition of use, the retread rim assembly has a corresponding second radial dimension that is of a size suitable for engaging and securing the associated tire on the retread rim assembly as well as for forming a substantially fluid-tight seal on or along bead areas 202 and 204 of associated tire TIRE. In a preferred arrangement, bead areas 202 and 204 are disposed in abutting engagement along surface 156 of retread band 126, and can form a substantially fluid-tight seal therebetween, as is schematically represented in FIG. 6 by dashed lines 210.

As is well known in the art, tires commonly include one or more plies containing a multiplicity of closely-spaced reinforcing cords or wires that extend across the crown portion of the tire casing and radially inward along the sidewalls of the tire casing. In the arrangement in FIGS. 5 and 6, for example, tire casing 188 is shown as including a reinforcing layer or ply 212 that extends across crown portion 190 and along sidewalls 192 and 194 toward bead areas 202 and 204. Further reinforcement of the tire can be provided by one or more annular belts, such as belts 214 that extend circumferentially along crown portion 190, for example. Reinforcing ply 212 and belts 214 can be fabricated of any suitable material or combination of materials, such as steel wires, polymeric cords and/or suitable textile cords, for example, as is well known in the art. Associated tire TIRE can also include a tread 216 that extends circumferentially about tire casing 188 and extends axially between opposing first and second shoulders 218 and 220, which shoulders generally transition tread 216 into sidewalls 192 and 194, respectively. Tread 216 can include any suitable combination of grooves, tread elements or lugs and tread void areas in any suitable size, shape and/or pattern, as is well known in the art.

Bead cores 206 can take the form of substantially-inextensible, endless rings that are embedded within bead areas 202 and 204. One function of bead reinforcing elements (e.g., bead cores 206) is to establish and maintain the cross-sectional dimension of bead areas 202 and 204 and the openings formed thereby such that the associated tire can be mounted along corresponding bead seats of an associated wheel, such as may be established by industry standards and conventions. Importantly, bead cores 206 also establish and maintain the cross-sectional dimension of bead areas 202 and 204 and the openings formed thereby during engagement with a retread rim assembly in accordance with the subject matter of the present disclosure. In this manner, retread rim assembly 122 can engage and secure associated tire TIRE on the retread rim assembly as well as form a substantially fluid-tight seal on or along bead areas 202 and 204 of associated tire TIRE.

Another function of bead reinforcing elements (e.g., bead cores 206) is to anchor reinforcing layers or plies, such as reinforcing ply 212, for example, as the same extends across the tire carcass between the opposing bead areas. It will be appreciated that the reinforcing elements of such one or more reinforcing plies can be anchored by bead cores 206 in any suitable manner. For example, reinforcing ply 212 is shown in FIGS. 5 and 6 as extending from along sidewalls 192 and 194 toward bead areas 206. Reinforcing ply 212 extends in a radially-inward direction along an axially-inward side of bead cores 206 and through the opening formed by the bead core. Outer ends 212A of reinforcing ply 212 are turned up along an axially-outward side of bead cores 206 and return in a radially-outward direction along sidewalls 192 and 194. Bead fillers 208 are shown disposed adjacent bead cores 206 in an area between reinforcing ply 212 and outer ends 212A, and can operate to at least partially fill any gap between reinforcing ply 212 and outer end 212A and/or can operate to provide added rigidity and/or stiffness to the bead area. It will be appreciated, however, that other arrangements and/or configurations could alternately be used, and that the arrangement shown is merely exemplary.

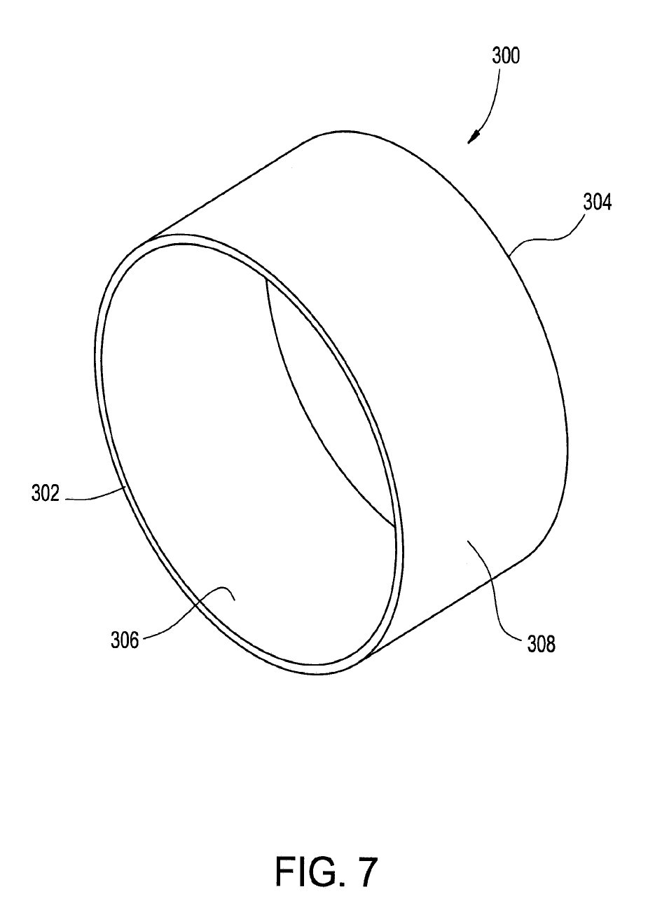

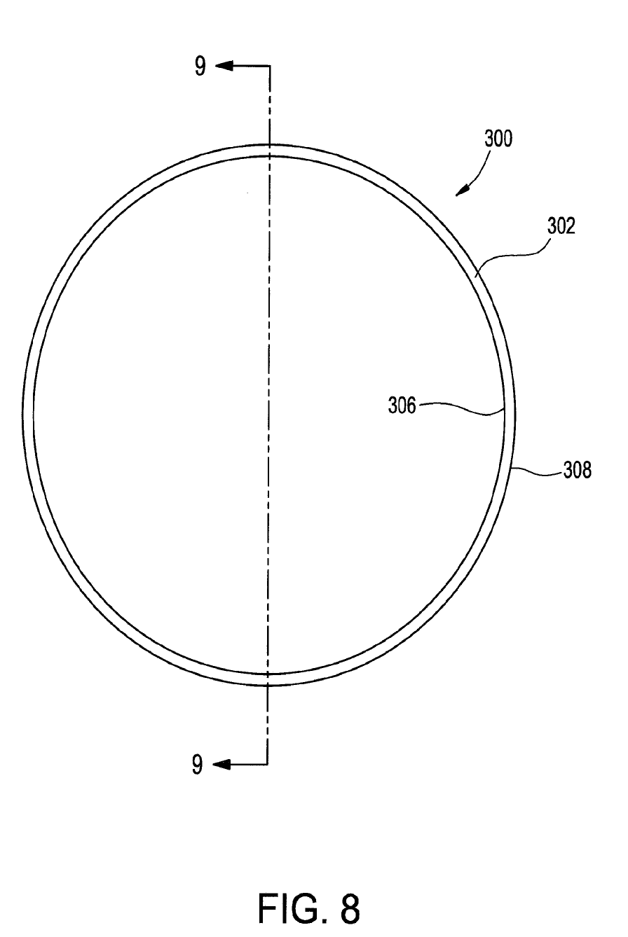

Having described an example of a retread rim assembly (i.e., retread rim assembly 122) in accordance with the subject matter of the present disclosure, one example of a retread band in accordance with the subject matter of the present disclosure that is suitable for use as retread band 126, which is shown and described above in connection with FIGS. 1-6, will now be described in connection with FIGS. 7-10. As shown therein, one example of a retread band 300 can have a longitudinally-extending axis AX and a midplane MP oriented transverse to longitudinal axis AX.

It will be appreciated that retread band 300 can be of any suitable size, shape, construction and/or configuration in accordance with the present disclosure. For example, retread band 300 is shown in FIGS. 7-10 as including an edge 302 and an edge 304 disposed in longitudinally-spaced relation to edge 302. Edges 302 and 304 extend annularly about longitudinal axis AX and can at least partially define a longitudinal length of retread band 300 therebetween. Retread band 300 can also include a surface 306 and a surface 308 that is spaced apart from surface 306 in a radial direction to at least partially define a height or thickness of retread band 300. In one example of a suitable construction, retread band 300 can have a cross-sectional configuration or shape that is at least approximately rectangular. It will be appreciated, however, that other configurations and/or arrangements could alternately be used, such as are shown and described hereinafter.

In an installed condition of retread band 300, such as is shown and described in connection with retread band 126 in FIGS. 1-6, edges 302 and 304 can respectively correspond to edges 150 and 152 with surfaces 306 and 308 respectively corresponding to surfaces 154 and 156 of retread band 126. In which case, surface 306 can function as an inner surface disposed in facing relation to base surface portions 146 and surface 308 can function as an outer surface facing radially outward from the base surface portions of rim segments 124.

As discussed above, retread bands in accordance with the subject matter of the present disclosure are at least partially formed from elastomeric material such that the retread bands can be circumferentially tensioned around the plurality of rim segments of the retread rim assembly to thereby bias the plurality of rim segments radially inward. In this manner, adjacent rim segments can be disposed in abutting engagement with one another in a free, natural or otherwise unexpanded condition of the retread rim assembly, such as is shown in FIG. 4, for example. It will be appreciated that retread bands in accordance with the subject matter of the present disclosure can include any suitable combination of one or more elastomeric materials.

As one example, retread band 300 can include a layer 310 that is at least partially formed from one elastomeric material. Retread band 300 can also include a layer 312 that is disposed along layer 310. Layer 312 can be at least partially formed from an elastomeric material that, in a preferred construction, is different from the elastomeric material of layer 310. Retread band 300 can further include a layer 314 disposed along layer 310 opposite layer 312. Again, layer 314 can be at least partially formed from an elastomeric material that, in a preferred construction, is different from the elastomeric material of at least layer 310.

In some cases, the elastomeric material of layer 310 can be an elastomeric material, such as a synthetic rubber, a natural rubber or a thermoplastic elastomer, that is suitable for undergoing many hundreds or thousands of expansion and recovery cycles without experiencing significant circumferential elongation or stretching. In many cases, materials having elastomeric properties suitable for such applications may have one or more other properties or characteristics that are less well suited for such use. For example, the elastomeric material of layer 310 may have an abrasion-resistance property or characteristic that results in undesirable wear performance during extended use. In such cases, the elastomeric material of layer 312 can have a greater abrasion-resistance property or characteristic than the elastomeric material of layer 310. Additionally, or in the alternative, the elastomeric material of layer 314 can have a greater abrasion-resistance property or characteristic than at least the elastomeric material of layer 310. In this manner, the resulting combination of different elastomeric materials result in a construction for retread band 300 that can provide overall improved performance over known constructions.

Additionally, in some cases, retread band 300 can, optionally, include a release layer or coating 316 disposed on or along layer 314 opposite layer 310. In some cases, layer 316 can at least partially form surface 308 of retread band 300. In other cases, surface 308 can be substantially entirely formed or otherwise established by layer 314 with coating 316 extending over less than the full area of surface 308. For example, release coating 316 can extend longitudinally along axially outward portions of surface 308 adjacent edges 302 and 304 in the annular zones in which bead areas 202 and 204 of associated tire TIRE are likely to engage retread band 300.

In a preferred construction, retread band 300 can also include at least one reinforcing layer or ply 318 that is at least partially embedded within at least one layer of elastomeric material from which the retread band is formed. It will be appreciated that the at least one reinforcing ply can be constructed from any suitable material or combination of materials capable of contributing to the desired performance characteristics of the retread band and, preferably, include one or more reinforcing filaments, yarns and/or cords, such as are discussed hereinafter. For purposes of convenience of discussion and without operating as a limitation, the one or more reinforcing filaments, yarns and/or cords are collectively referred to herein as “reinforcing elements”. The one or more reinforcing elements can be of any suitable type, kind and/or construction and can be formed from any suitable material or combination of materials. For example, the one or more reinforcing elements could take the form of monofilaments or twisted strands of fibers. Additionally, the one or more reinforcing elements could, for example, be formed from natural fibers (e.g., cotton yarn) or polymeric filaments (e.g., nylon or aramid cords).

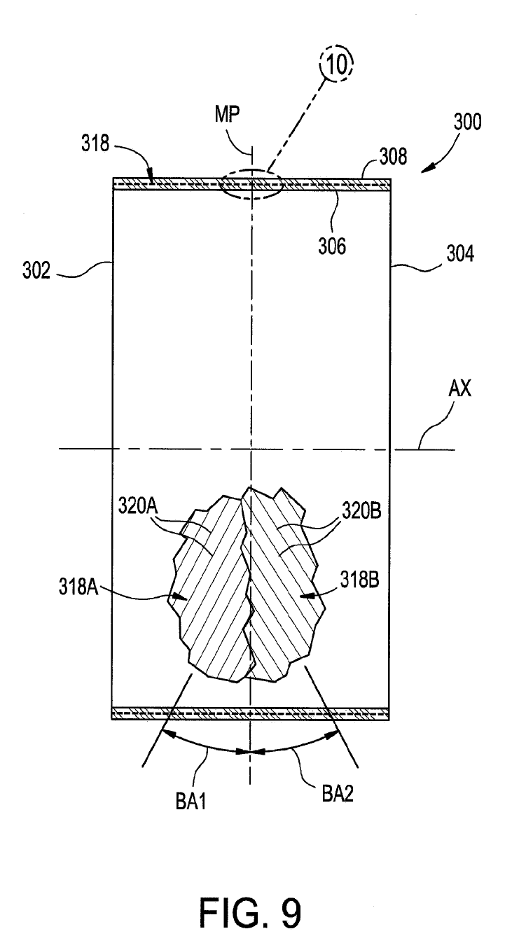

Additionally, in a preferred construction, at least one reinforcing ply 318 can extend lengthwise along at least a portion of retread band 300 and annularly about axis AX. In some cases, the at least one reinforcing ply can extend in a lengthwise direction between edged 302 and 304 such that one or more reinforcing elements are exposed therealong. Furthermore, it will be appreciated that the one or more reinforcing filaments, yarns and/or cords of the at least one reinforcing ply can be disposed in any suitable arrangement and/or configuration. For example, retread band 300 can include a single reinforcing ply 318A that includes a plurality of reinforcing elements 320A disposed at a bias angle relative to midplane MP, as is represented in FIG. 9 by reference dimension BA1. In cases in which a single reinforcing ply is used, bias angle BA1 of reinforcing elements 320A is preferably an acute angle within a range of from approximately zero (0) degrees to approximately ten (10) degrees.

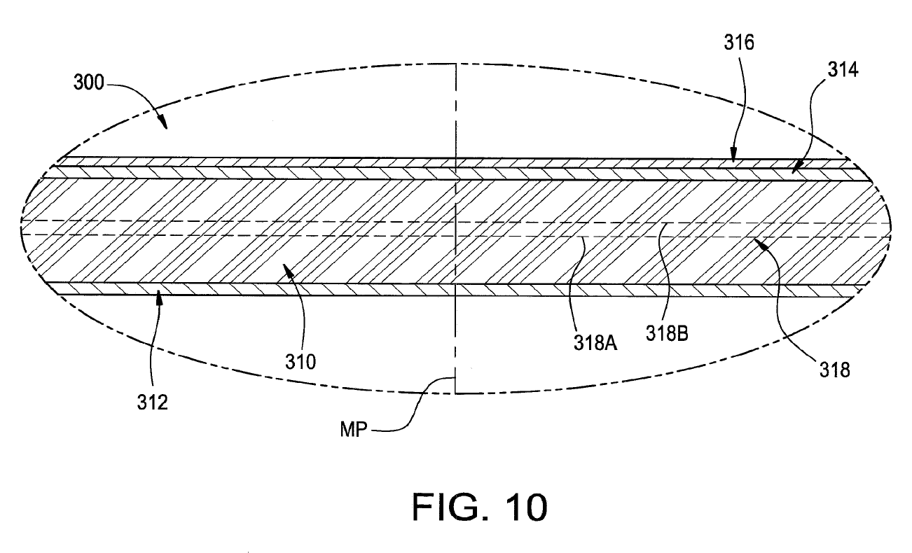

In other cases, the at least one reinforcing ply can include at least two reinforcing plies 318A and 318B with one of the reinforcing plies spaced radially outward from the other reinforcing ply, such as is shown in FIG. 10, for example. In such cases, reinforcing plies 318A and 318B can each respectively include a plurality of reinforcing elements 320A and 320B. In which case, the plurality of reinforcing elements are preferably disposed at a non-zero bias angle with respect to midplane MP such that the reinforcing elements extend both longitudinally and peripherally along the reinforcing plies. As shown in FIG. 9, for example, reinforcing ply 318A can include reinforcing elements 320A disposed at a bias angle that is represented by reference dimension BA1, and reinforcing ply 318B can include reinforcing elements 320B disposed at a bias angle that is represented by reference dimension BA2. It will be appreciated that any suitable bias angle or range of bias angles can be used for reinforcing elements 320A and 320B, such as a bias angle within a range of from approximately zero (0) degrees to approximately thirty (30) degrees, for example. In a more preferred construction bias angles BA1 and BA2 can be within a range of from approximately ten (10) degrees to approximately twenty five (25) degrees. Additionally, it will be appreciated that the reinforcing elements of the at least two reinforcing plies can be disposed at the same or a different bias angle with respect to one another. In one exemplary arrangement, such as is shown in FIG. 9, bias angles BA1 and BA2 are at least approximately equal to one another but are oriented in opposing directions.

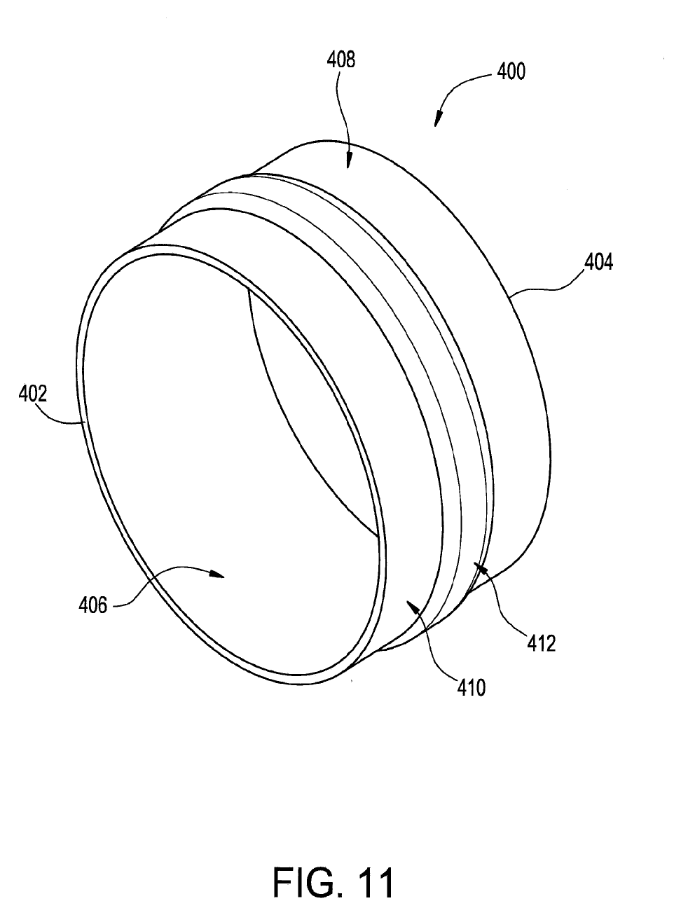

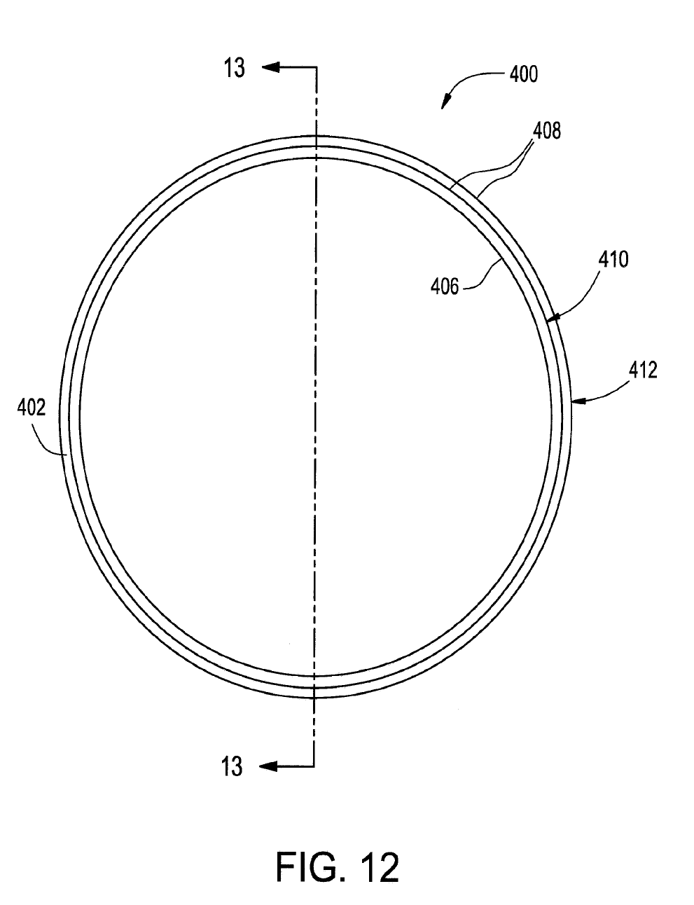

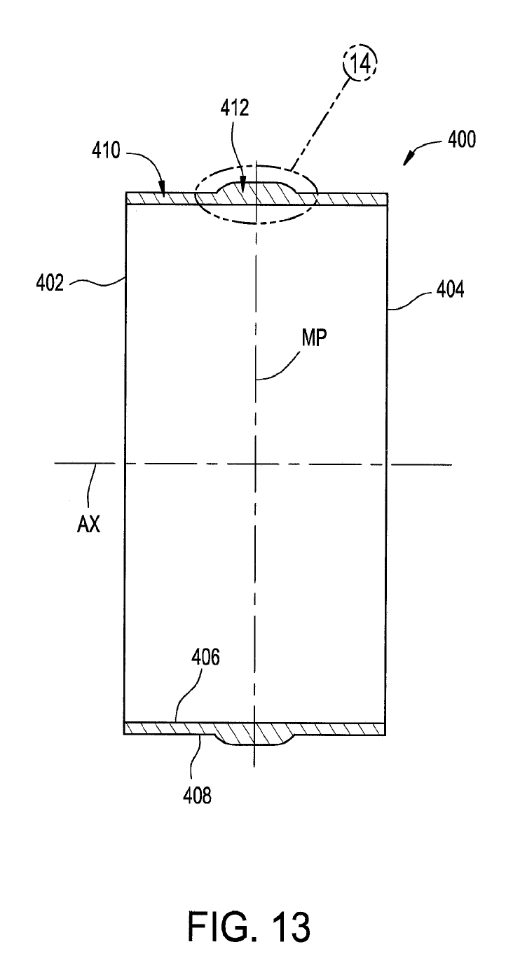

Again, having previously described an example of a retread rim assembly (i.e., retread rim assembly 122) in accordance with the subject matter of the present disclosure, another example of a retread band in accordance with the subject matter of the present disclosure that is suitable for use as retread band 126, which is shown and described above in connection with FIGS. 1-6, will now be described in connection with FIGS. 11-15. As shown therein, another example of a retread band 400 can have a longitudinally-extending axis AX and a midplane MP oriented transverse to longitudinal axis AX.

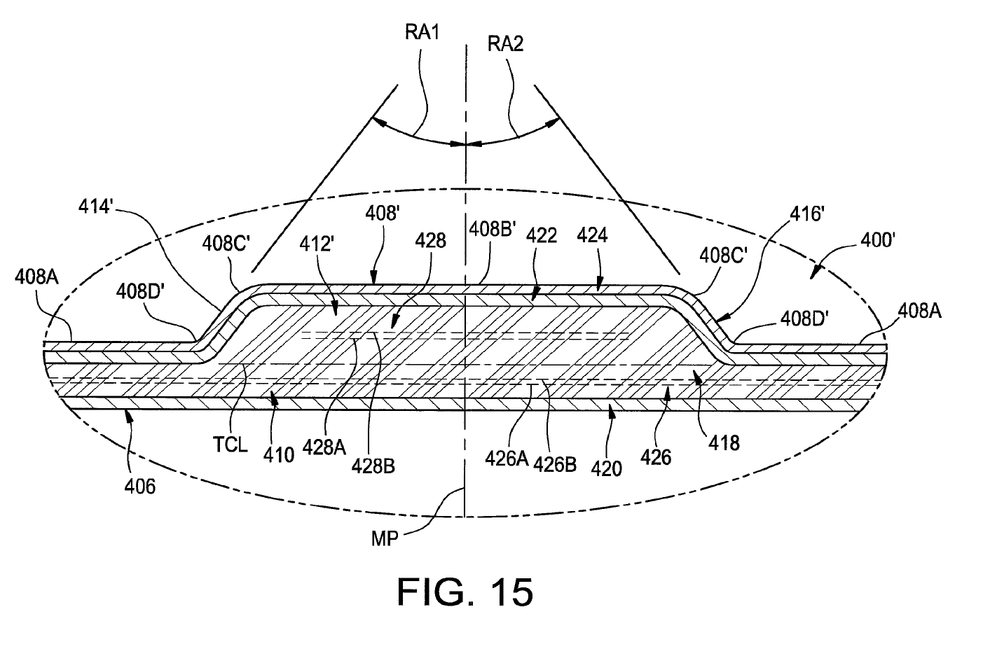

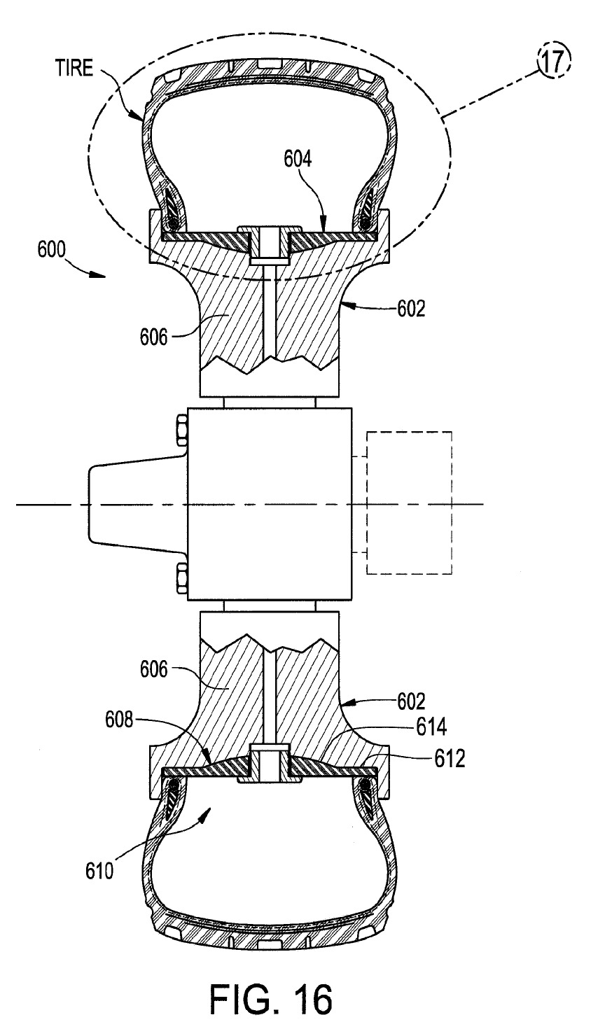

It will be appreciated that retread band 400 can be of any suitable size, shape, construction and/or configuration in accordance with the present disclosure. For example, retread band 400 is shown in FIGS. 11-15 as including an edge 402 and an edge 404 disposed in longitudinally-spaced relation to edge 402. Edges 402 and 404 extend annularly about longitudinal axis AX and can at least partially define a longitudinal length of retread band 400 therebetween. Retread band 400 can also include a surface 406 and a surface 408 that is spaced apart from surface 406 in a radial direction to at least partially define a height or thickness of retread band 400. In one example of a suitable construction, retread band 400 can have a cross-sectional configuration or shape with a base portion 410 that is at least approximately rectangular and a rib portion 412 that projects radially outward from along base portion 410. FIG. 15 illustrates an alternate construction of a retread band 400′ that includes a rib portion 412′ having an alternate shape in comparison with rib portion 412 in FIGS. 11-14. It will be appreciated, however, that other configurations and/or arrangements could alternately be used. For example, a retread band can have one or more rib portions that extend radially inward from along the base portion, such as are shown and described herein in connection with FIGS. 16-22, for example.

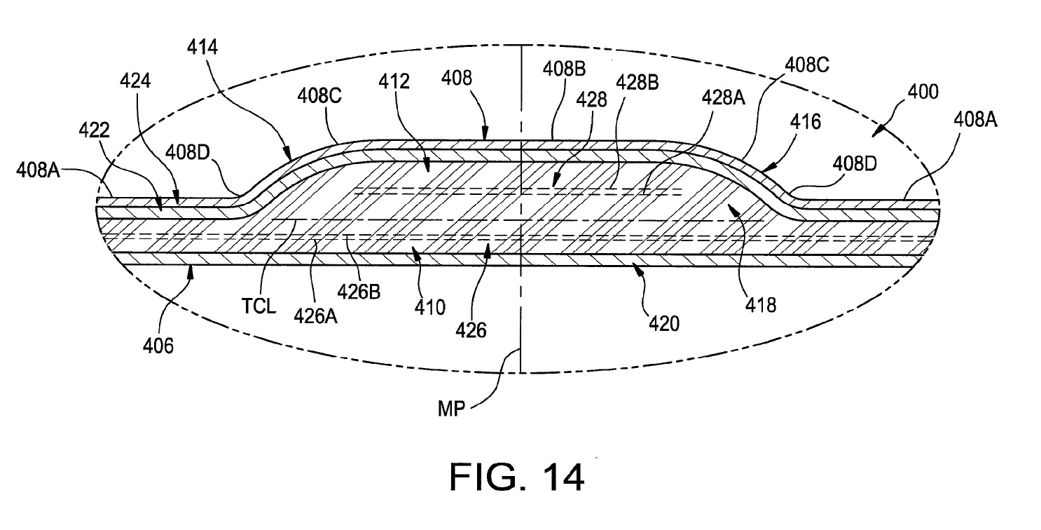

As shown in FIGS. 14 and 15, base portion 410 and rib portions 412 and 412′ respectively of retread bands 400 and 400′ are shown as being disposed along opposing sides of theoretical construction line TCL. It is to be recognized and understood that line TCL is included solely of illustrative purposes to approximate a demarcation between the base portion and the rib portions, and is not intended to represent an actual element or component of the retread bands or a specific position, size or proportion of the base and rib portions relative to one another.

As discussed above, base portion 410 of retread band 400 and 400′ can have an approximately rectangular cross-sectional shape or configuration. Rib portions 412 and 412′ project radially outward from along base portion 410 and separate surface 408 into at least one base surface portion 408A and rib surface portions 408B and 4086′. In the arrangement shown in FIGS. 11-15, rib portions 412 and 412′ are approximately centered along midplane MP of the retread bands. As such, two base surface portions 408A are formed along opposing sides of the rib portions adjacent edges 402 and 404.

As shown in FIGS. 11-14, rib portion 412 extends longitudinally between rib edges 414 and 416, which have a curvilinear configuration suitable for facilitating the transfer of an associated tire onto and off of the retread rim assembly. Rib edges 414 and 416 can, optionally, include one or more transition portions extending between and operatively connecting the rib edges with base surface portions 408A and/or rib surface portions 408B and/or 4086′. In the arrangement shown in FIGS. 11-14, transition surface portions 408C and 408D extend between and operatively connect rib portions 414 and 416 with respective ones of base surface portions 408A and rib surface portion 408B. In a preferred arrangement, transition surface portions 408C and 408D have a curvilinear construction suitable for facilitating the transfer of an associated tire onto and off of the retread rim assembly.

As shown in FIG. 15, rib portion 412′ extend longitudinally between rib edges 414′ and 416′, which have an approximately linear configuration with the rib edges oriented at an acute angle relative to midplane MP resulting in rib portion 412′ having a somewhat trapezoidal cross-sectional shape. The orientation of rib edges 414′ and 416′ is represented in FIG. 15 by reference dimensions RA1 and RA2. It will be appreciated that any suitable angles or range of angles can be used for rib edges 414′ and 416′, such as angles within a range of from approximately twenty (20) degrees to approximately forty five (45) degrees, for example. In a more preferred construction angles RA1 and RA2 can be within a range of from approximately thirty (30) degrees to approximately thirty five (35) degrees. Additionally, it will be appreciated that the rib edges can be disposed at the same or a different angles with respect to one another. In one exemplary arrangement, such as is shown in FIG. 15, angles RA1 and RA2 are at least approximately equal to one another but are oriented in opposing directions.

Rib edges 414′ and 416′ can, optionally, include one or more transition portions extending between and operatively connecting the rib edges with base surface portions 408A and/or rib surface portion 408B′. In the arrangement shown in FIG. 15, transition surface portions 408C′ and 408D′ extend between and operatively connect rib portions 414′ and 416′ with respective ones of base surface portions 408A and rib surface portion 408B′. In a preferred arrangement, transition surface portions 408C′ and 408D′ have a curvilinear construction suitable for facilitating the transfer of an associated tire onto and off of the retread rim assembly.

In an installed condition of retread band 400, such as is shown and described in connection with retread band 126 in FIGS. 1-6, edges 402 and 404 can respectively correspond to edges 150 and 152 with surfaces 406 and 408 respectively corresponding to surfaces 154 and 156 of retread band 126. In which case, surface 406 can function as an inner surface disposed in facing relation to base surface portions 146 and surface 408 can function as an outer surface facing radially outward from the base surface portions of rim segments 124.

As discussed above, retread bands in accordance with the subject matter of the present disclosure are at least partially formed from elastomeric material such that the retread bands can be circumferentially tensioned around the plurality of rim segments of the retread rim assembly to thereby bias the plurality of rim segments radially inward. In this manner, adjacent rim segments can be disposed in abutting engagement with one another in a free, natural or otherwise unexpanded condition of the retread rim assembly, such as is shown in FIG. 4, for example. It will be appreciated that retread bands in accordance with the subject matter of the present disclosure can include any suitable combination of one or more elastomeric materials.

As one example, retread band 400 can include a layer 418 that is at least partially formed from one elastomeric material. As shown in FIGS. 14 and 15, layer 418 can form at least some of base portion 410 and/or at least some of rib portions 412 and/or 412′. Retread band 400 can also include a layer 420 that is disposed along layer 418. Layer 420 can be at least partially formed from an elastomeric material that, in a preferred construction, is different from the elastomeric material of layer 418. Additionally, layer 420 can form at least some of base portion 410. Retread band 400 can further include a layer 422 disposed along layer 418 opposite layer 420. Again, layer 422 can be at least partially formed from an elastomeric material that, in a preferred construction, is different from the elastomeric material of at least layer 418. And, layer 422 can form at least some of base portion 410 and/or at least some of rib portions 412 and/or 412′.

In some cases, the elastomeric material of layer 418 can be an elastomeric material, such as a synthetic rubber, a natural rubber or a thermoplastic elastomer, that is suitable for undergoing many hundreds or thousands of expansion and recovery cycles without experiencing significant circumferential elongation or stretching. In many cases, materials having elastomeric properties suitable for such applications may have one or more other properties or characteristics that are less well suited for such use. For example, the elastomeric material of layer 418 may have an abrasion-resistance property or characteristic that results in undesirable wear performance during extended use. In such cases, the elastomeric material of layer 420 can have a greater abrasion-resistance property or characteristic than the elastomeric material of layer 418. Additionally, or in the alternative, the elastomeric material of layer 422 can have a greater abrasion-resistance property or characteristic than at least the elastomeric material of layer 418. In this manner, the resulting combination of different elastomeric materials result in a construction for retread band 400 that can provide overall improved performance over known constructions.

Additionally, in some cases, retread band 400 can, optionally, include a release layer or coating 424 disposed on or along layer 422 opposite layer 418. In some cases, layer 424 can at least partially form surface 408 of retread band 400. In other cases, surface 408 can be substantially entirely formed or otherwise established by layer 422 with coating 424 extending over less than the full area of surface 408. For example, release coating 424 can extend longitudinally along axially outward portions of surface 408 adjacent edges 402 and 404 in the annular zones in which bead areas 202 and 204 of associated tire TIRE are likely to engage retread band 400.

Retread bands 400 and/or 400′ can, optionally, include one or more reinforcing layers or plies 426 that are at least partially embedded within at least one layer of elastomeric material from which base portion 410 of retread bands 400 and/or 400′ is formed. Additionally, or in the alternative, retread bands 400 and/or 400′ can, optionally, include one or more reinforcing layers or plies 428 that are at least partially embedded within at least one layer of elastomeric material from which rib portion 412 and/or 412′ of retread bands 400 and/or 400′ are formed. In some cases, a single reinforcing layer or ply can be at least partially embedded within either or both of the base portion and the rib portion. In other cases, two or more reinforcing layers or plies can be at least partially embedded within either or both of base portion 410 and rib portion 412, such as are respectively represented by dashed lines 426A/426B and 428A/428B in FIGS. 14 and 15, for example.

It will be appreciated that such one or more reinforcing layers or plies can be constructed from any suitable material or combination of materials capable of contributing to the desired performance characteristics of the retread band and, preferably, include one or more reinforcing filaments, yarns and/or cords, such as are discussed hereinafter. For purposes of convenience of discussion and without operating as a limitation, the one or more reinforcing filaments, yarns and/or cords are collectively referred to herein as “reinforcing elements”. The one or more reinforcing elements can be of any suitable type, kind and/or construction and can be formed from any suitable material or combination of materials. For example, the one or more reinforcing elements could take the form of monofilaments or twisted strands of fibers. Additionally, the one or more reinforcing elements could, for example, be formed from natural fibers (e.g., cotton yarn) or polymeric filaments (e.g., nylon or aram id cords).

It will be appreciated that any one or more of reinforcing plies 426A, 426B, 428A and/or 428B can be constructed in a manner substantially similar to reinforcing plies 318, 318A, 318B and/or reinforcing elements 320A and/or 320B, which are shown and described in detail in connection with FIGS. 7-10. For purposes of brevity and ease of reading, a detailed description of reinforcing plies 426A, 426B, 428A and/or 428B and/or the reinforcing elements thereof is not repeated here. It is to be recognized and understood, however, that the foregoing description of reinforcing plies 318, 318A, 318B as well as reinforcing elements 320A and/or 320B, including all of the features and functions thereof as well as any components that associated therewith, is equally applicable to reinforcing plies 426A, 426B, 428A and/or 428B and/or the reinforcing elements thereof as if recited in full detail herein.

Having described one example of a retread rim assembly (i.e. retread rim assembly 122) and suitable retread bands (i.e. retread band 126), which are shown and described in connection with FIGS. 1-15, additional examples of retread rim assemblies and retread bands will now be described in connection with FIGS. 16-22. As shown herein, each example can have a longitudinally-extending axis AX and a midplane MP oriented transverse to longitudinal axis AX.

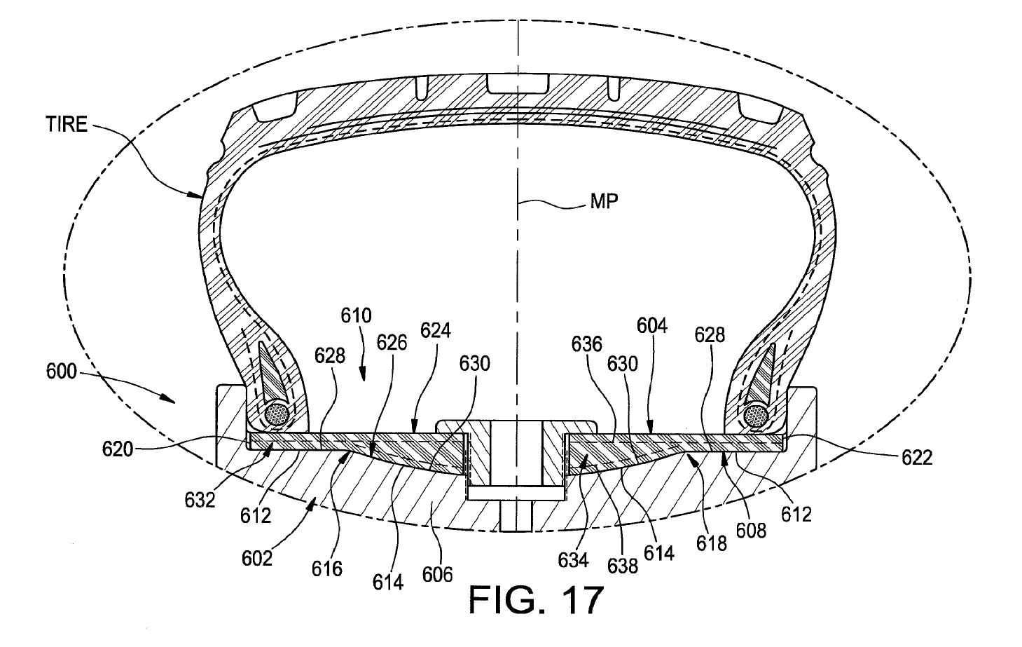

As identified in at least FIGS. 16 and 17, a retread rim assembly 600 is configured such that an associated tire TIRE can be supported thereon for performance of one or more operations of a tire retreading process, such as has been described in detail above. Retread rim assemblies 600 can include a plurality of rim segments 602 and one or more retread bands 604. It will be appreciated that retread rim assemblies 600 including rim segments 602 thereof are substantially similar to retread rim assemblies 122 and rim segments 124 thereof. Thus, for purposes of brevity and ease of reading, a detailed description of retread rim assemblies 600 and/or rim segments 602 thereof is not repeated here. It is to be recognized and understood, however, that the foregoing description of retread rim assemblies 122 and rim segments 124, including all of the features and functions thereof as well as any components that associated therewith, is equally applicable to retread rim assemblies 600 as well as rim segments 602 thereof as if recited in full detail herein.

As shown in FIGS. 16 and 17, rim segments 602 can include segment bodies 606 having a surface portion 608 that defines at least one segment channel 610 extending radially inward into segment bodies 606 about longitudinal axis AX. Rim segments 602 differ from rim segments 124 at least in that surface portion 608 of segment body 606 includes a base surface portion 612 and a groove surface portion 614 that at least partially defines an annular groove segment (not numbered) along surface portion 608 of segment channel 610. Groove surface portion 614 can extend from groove edge 616 to a groove edge 618 that is spaced axially from groove edge 616. In one exemplary arrangement, groove surface portion 614 can have a curvilinear cross-sectional shape or profile that can gradually increase from groove edge 616 to a maximum depth (not numbered) adjacent midplane MP, and then gradually decreasing to groove edge 618. As such, the annular groove segment can have a curved or otherwise non-linear cross-sectional shape or profile.

It will be appreciated that retread bands 604 can include features and/or functions similar to those of retread bands 126, 300 and 400 that are shown and described herein. For purposes of brevity and ease of reading, a detailed description of retread bands 604 may not be repeated here. It is to be recognized and understood, however, that the foregoing description of retread bands 126, 300 and 400, including all of the features and functions thereof as well as any components that associated therewith, is equally applicable to retread bands 604 as if recited in full detail herein.

Retread band 604 is shown in FIGS. 16 and 17 as having an outer edge 620 and an outer edge 622 that is spaced longitudinally from outer edge 620 and defines a band length (not identified) therebetween. Retread band 604 also includes surfaces 624 and 626 that face generally opposite one another and extend axially between outer edges 620 and 622. Surfaces 624 and 626 are spaced apart from one another and at least partially define the thickness or height (not identified) of the retread band. As shown in FIGS. 16 and 17, retread band 604 can have a cross-sectional configuration or shape with a base portion 628 that is at least approximately rectangular and a rib portion 630 that projects in a radial direction from along base portion 628. In the arrangement shown, rib portion 630 extends from along base portion 628 in a radially-inward direction.

Surface 626 can include a base surface portion 632 that is dimensioned for cooperative engagement with base surface portion 612 of segment body 606, and a rib surface portion 634 that is dimensioned for cooperative engagement with the annular groove segment that is at least partially defined by groove surface portion 614 of segment body 628. Additionally, retread band 604 can, optionally, include one or more reinforcing layers or plies that are at least partially embedded within at least one layer of elastomeric material from which retread band 604 is formed. Any such one or more reinforcing layers or plies can be included in either or both of base portion 628 and rib portion 630, such as are represented in FIG. 17 by dashed lines 636 and 638.

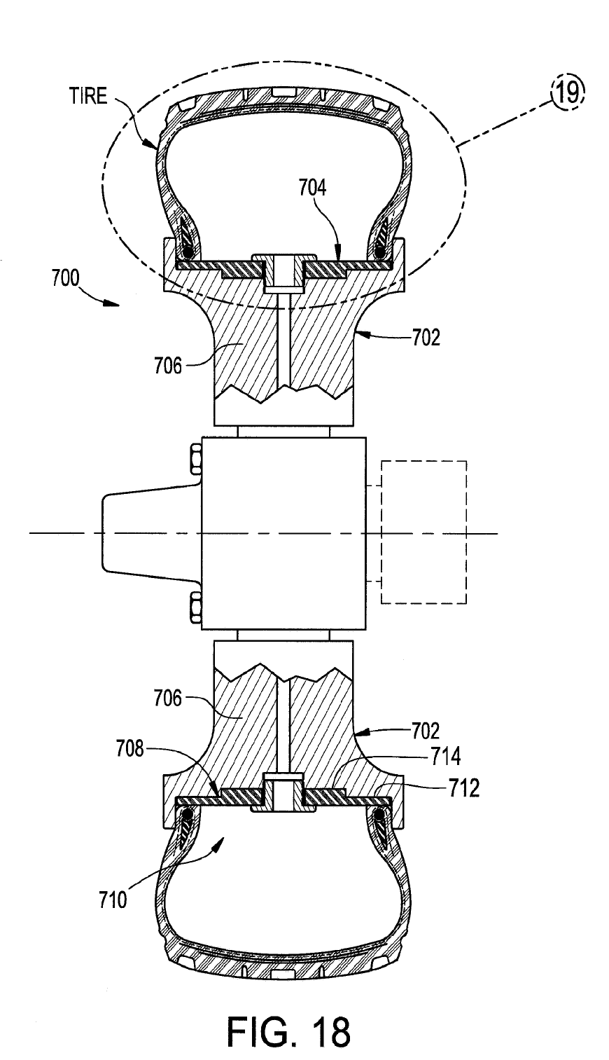

As identified in at least FIGS. 18-20, a retread rim assembly 700 is configured such that an associated tire TIRE can be supported thereon for performance of one or more operations of a tire retreading process, such as has been described in detail above. Retread rim assemblies 700 can include a plurality of rim segments 702 and one or more retread bands 704. It will be appreciated that retread rim assemblies 700 including rim segments 702 thereof are substantially similar to retread rim assemblies 122 and rim segments 124 thereof. Thus, for purposes of brevity and ease of reading, a detailed description of retread rim assemblies 700 and/or rim segments 702 thereof is not repeated here. It is to be recognized and understood, however, that the foregoing description of retread rim assemblies 122 and rim segments 124, including all of the features and functions thereof as well as any components that associated therewith, is equally applicable to retread rim assemblies 700 as well as rim segments 702 thereof as if recited in full detail herein.

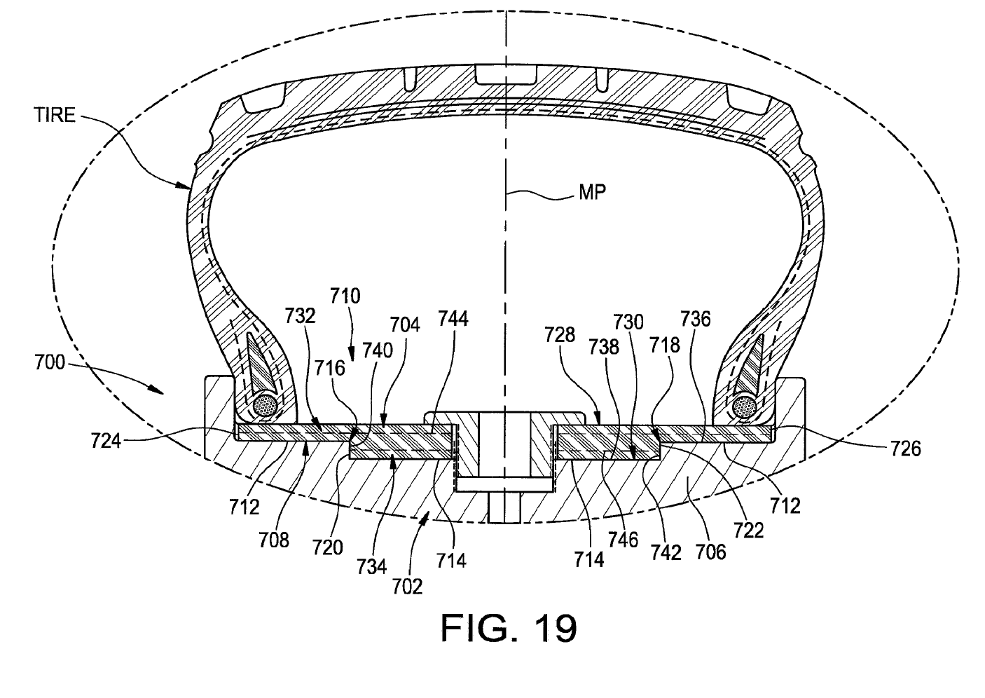

As shown in FIGS. 18 and 19, rim segments 702 can include segment bodies 706 having a surface portion 708 that defines at least one segment channel 710 extending radially inward into segment bodies 706 about longitudinal axis AX. Rim segments 702 differ from rim segments 124 at least in that surface portion 708 of segment body 706 includes base surface portions 712 and a groove surface portion 714 that at least partially defines an annular groove segment (not numbered) along surface portion 708 of segment channel 710. Groove surface portion 714 can extend from groove edge 716 to a groove edge 718 that is spaced axially from groove edge 716. Surface portion 708 can also include side surface portions 720 and 722, which can extend radially inwardly into segment body 706 such as from along groove edges 716 and 718, respectively, and further define the annular groove segment of the at least one segment channel. In some cases, side surface portions 720 and 722 can have an approximately linear cross-sectional profile, and can be oriented transverse to base surface portion 712 and groove surface portion 714 such that the annular groove segment has an approximately rectangular cross-sectional shape or profile.

Retread band 704 is shown in FIGS. 18 and 19 as having an outer edge 724 and an outer edge 726 that is spaced longitudinally from outer edge 724 and defines a band length (not identified) therebetween. Retread band 704 also includes surfaces 728 and 730 that face generally opposite one another and extend axially between outer edges 724 and 726. Surfaces 728 and 730 are spaced apart from one another and at least partially define the thickness or height (not identified) of the retread band. As shown in FIGS. 18 and 19, retread band 704 can have a cross-sectional configuration or shape with a base portion 732 that is at least approximately rectangular and a rib portion 734 that projects in a radial direction from along base portion 732. In the arrangement shown, rib portion 734 extends from along base portion 732 in a radially-inward direction.

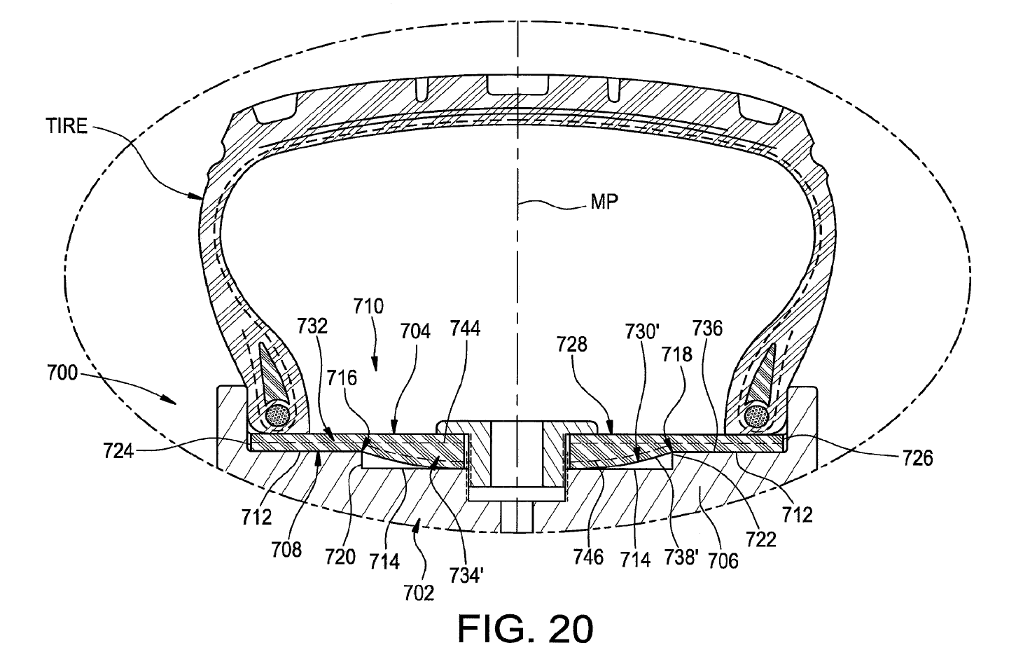

Surface 730 can include a base surface portion 736 that is dimensioned for cooperative engagement with base surface portion 712 of segment body 706, and a rib surface portion 738 that is dimensioned for cooperative engagement with the annular groove segment that is at least partially defined by groove surface portion 714 of segment body 706. Surface 730 can also include side surface portions 740 and 742 that are disposed in axially-spaced relation to one another and dimensioned for cooperative engagement with side surface portions 720 and 722 of surface portion 708 of segment body 706. In such case, surface portions 708 and 730 can, in some cases, be in substantially continuously contact with one another between outer edges 724 and 726. In an alternative construction, as shown in FIG. 20, a surface portion 730′ can at least partially define a rib portion 734′ that can include a rib surface portion 738′ having a curvilinear or other non-linear cross-sectional shape or profile, such as has been described above in connection with rib surface portion 634 in FIGS. 16 and 17, for example. In such case, it will be appreciated that only a portion of rib surface portion 738′ may contact one or more of groove surface portion 714 and/or side surface portions 720 and/or 722.

Additionally, retread band 704 can, optionally, include one or more reinforcing layers or plies that are at least partially embedded within at least one layer of elastomeric material from which retread band 704 is formed. Any such one or more reinforcing layers or plies can be included in either or both of base portion 732 and rib portions 734, such as are represented in FIGS. 19 and 20 by dashed lines 744 and 746.

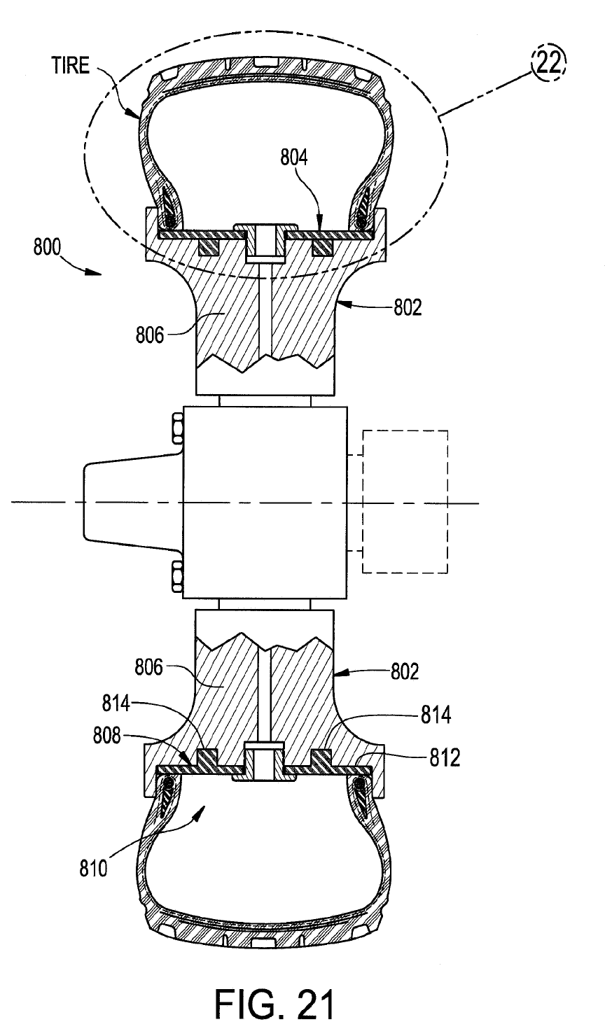

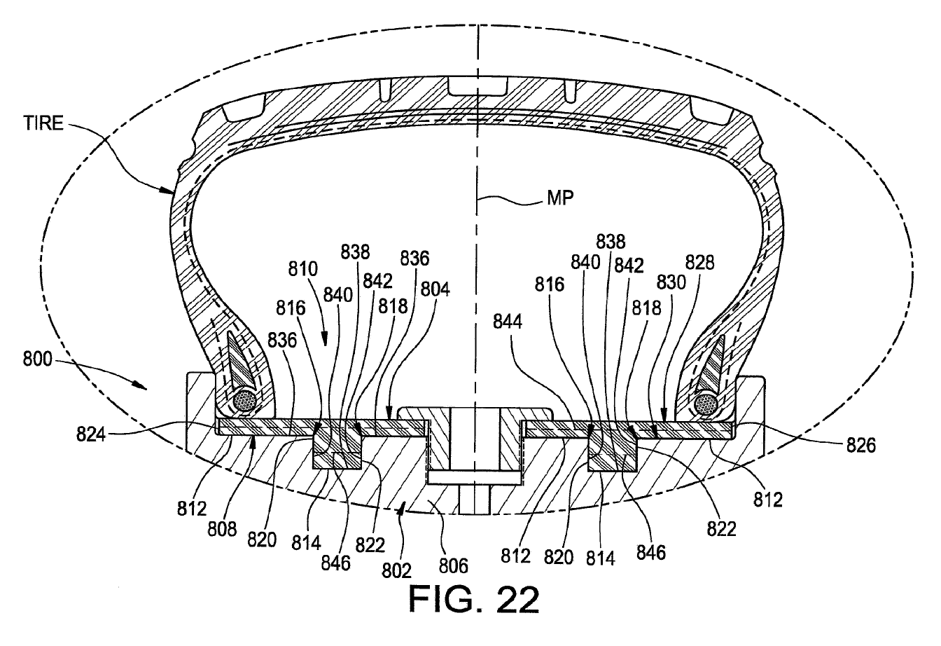

As identified in at least FIGS. 21 and 22, a retread rim assembly 800 is configured such that an associated tire TIRE can be supported thereon for performance of one or more operations of a tire retreading process, such as has been described in detail above. Retread rim assemblies 800 can include a plurality of rim segments 802 and one or more retread bands 804. It will be appreciated that retread rim assemblies 800 including rim segments 802 thereof are substantially similar to retread rim assemblies 122 and rim segments 124 thereof. Thus, for purposes of brevity and ease of reading, a detailed description of retread rim assemblies 800 and/or rim segments 802 thereof is not repeated here. It is to be recognized and understood, however, that the foregoing description of retread rim assemblies 122 and rim segments 124, including all of the features and functions thereof as well as any components that associated therewith, is equally applicable to retread rim assemblies 800 as well as rim segments 802 thereof as if recited in full detail herein.

As shown in FIGS. 21 and 22, rim segments 802 can include segment bodies 806 having a surface portion 808 that defines at least one segment channel 810 extending radially inward into segment bodies 806 about longitudinal axis AX. Rim segments 802 differ from rim segments 124 at least in that surface portion 808 of segment body 806 includes base surface portions 812 and groove surface portion 814 that are disposed in spaced relation to one another along opposing sides of midplane MP. Grooved surface portions 814 can each at least partially define an annular groove segment (not numbered) on opposing sides of midplane MP and along surface portion 808 of segment channel 810.

Each of groove surface portions 814 can extend from groove edge 816 to a groove edge 818 that is spaced axially from groove edge 816. Surface portion 808 can also include side surface portions 820 and 822, which can extend radially inward into segment body 806 such as from along groove edges 816 and 818, respectively, and can further define the annular groove segments. In some cases, side surface portions 820 and 822 can have an approximately linear cross-sectional profile, and can be oriented transverse to base surface portion 812 and groove surface portion 814 such that the annular groove segments have an approximately rectangular cross-sectional shape or profile.

Retread band 804 is shown in FIGS. 21 and 22 as having an outer edge 824 and an outer edge 826 that is spaced longitudinally from outer edge 824 and defines a band length (not identified) therebetween. Retread band 804 also includes surfaces 828 and 830 that face generally opposite one another and extend axially between outer edges 824 and 826. Surfaces 828 and 830 are spaced apart from one another and at least partially define the thickness or height (not identified) of the retread band. As shown in FIGS. 21 and 22, retread band 804 can have a cross-sectional configuration or shape with a base portion 832 that is at least approximately rectangular and rib portions 834 that project in a radial direction from along base portion 832. In the arrangement shown, rib portions 834 extends from along base portion 732 in a radially-inward direction.

Surface 830 can include base surface portions 836 that are dimensioned for cooperative engagement with base surface portion 812 of segment body 806, and rib surface portions 838 that are dimensioned for cooperative engagement with the annular groove segments that are at least partially defined by groove surface portion 814 of segment body 806. Surface 830 can also include side surface portions 840 and 842 that are disposed in axially-spaced relation to one another and dimensioned for cooperative engagement with side surface portions 820 and 822 of surface portion 808 of segment body 806. In such case, surface portions 808 and 830 can, in some cases, be in substantially continuously contact with one another between outer edges 824 and 826.

Additionally, retread band 804 can, optionally, include one or more reinforcing layers or plies that are at least partially embedded within at least one layer of elastomeric material from which retread band 804 is formed. Any such one or more reinforcing layers or plies can be included in either or both of base portions 832 and rib portions 834, such as are represented in FIGS. 21 and 22 by dashed lines 844 and 846.

As used herein, terms such as “fiber,” “filament,” and the like, are used interchangeably in reference to individual elements of material having a small cross-sectional dimension and an indefinite elongated length.

As used herein, terms such as “yarn”, “tow” and the like, are used in reference to a plurality of filaments that are laid, twisted and/or otherwise bundled together in a continuous, elongated strand of indefinite length. As one example, a yarn can include a quantity of filaments within a range of from approximately 10 filaments to approximately 500,000 filaments depending upon the type and kind of material from which the filaments are made.

As used herein, terms such as “cord” and the like, are used in reference to the product of one or more yarns that may be laid, twisted or otherwise bundled together in a continuous, elongated strand of indefinite length. In some cases, the one or more yarns may be treated with a binder, adhesive and/or matrix material.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the terms “transverse,” and the like, are to be broadly interpreted. As such, the terms “transverse,” and the like, can include a wide range of relative angular orientations that include, but are not limited to, an approximately perpendicular angular orientation. Also, the terms “circumferential,” “circumferentially,” and the like, are to be broadly interpreted and can include, but are not limited to circular shapes and/or configurations. In this regard, the terms “circumferential,” “circumferentially,” and the like, can be synonymous with terms such as “peripheral,” “peripherally,” and the like.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus it is to be distinctly understood that claims directed to any such combination of features and/or components, whether or not specifically embodied herein, are intended to find support in the present disclosure.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. A retread rim assembly dimensioned to receive an associated tire having associated tire beads, said retread rim assembly comprising:
a plurality of rim segments disposed in a generally circular arrangement about a central axis, said plurality of rim segments including a segment body extending radially between an inner end and an outer periphery disposed radially outward of said inner end, said segment body including a first end surface and a second end surface oriented at an acute angle relative to said first end surface, and said segment body including a first edge wall disposed along said outer periphery, a second edge wall spaced axially from said first edge wall along said outer periphery and a base surface extending axially between said first and second edge walls with said base surface and said first and second edge walls extending arcuately between said first and second end surfaces; and,
a retread band at least partially formed from an elastomeric material, said retread band extending lengthwise from a first edge to a second edge spaced axially from said first edge and extending peripherally about said central axis such that a midplane is disposed between said first and second edges that is oriented transverse to said central axis, said retread band having an inner surface facing radially inward and an outer surface facing radially outward, said retread band including at least one reinforcing ply at least partially embedded within said elastomeric material, said at least one reinforcing ply including a plurality of reinforcing filaments extending circumferentially about said central axis such that said plurality of reinforcing filaments are axially spaced apart from one another between said first and second edges;
said retread band disposed around said plurality of rim segments such that said inner surface is disposed in abutting engagement with said base surfaces of said plurality of rim segments, and said retread band being circumferentially tensioned to bias said plurality of rim segments radially inward such that adjacent rim segments are disposed in abutting engagement with one another along said first and second end surfaces.

2.-5. (canceled)

6. A retread rim assembly according to claim 1, wherein said at least one reinforcing ply includes a first reinforcing ply with a first plurality of reinforcing filaments extending circumferentially around said axis and oriented at a first bias angle relative to said midplane with said first bias angle being within a range of from approximately zero (0) degrees to approximately ten (10) degrees.

7. (canceled)

8. A retread rim assembly according to claim 1, wherein said at least one reinforcing ply includes a first reinforcing ply that includes a first plurality of reinforcing filaments extending circumferentially around said axis and oriented at a first bias angle relative to said midplane with said first bias angle being within a range of from approximately zero (0) degrees to approximately thirty (30) degrees.

9. (canceled)

10. A retread rim assembly according to claim 8, wherein said at least one reinforcing ply includes a second reinforcing ply disposed radially outward of said first reinforcing ply, said second reinforcing ply including a second plurality of reinforcing elements extending circumferentially around said axis and oriented at a second bias angle relative to said midplane with said second bias angle being within a range of from approximately zero (0) degrees to approximately thirty (30) degrees.

11. (canceled)

12. A retread rim assembly according to claim 10, wherein said first bias angle and said second bias angle are approximately equal in magnitude and oriented in opposing directions relative to one another.

13.-21. (canceled)

22. A retread rim assembly according to claim 1, wherein said elastomeric material of said retread band includes a first elastomeric material having a first abrasion-resistance property and a second elastomeric material having a second abrasion-resistance property that is greater than said first abrasion-resistance property of said first elastomeric material with said second elastomeric material at least partially defining said inner surface of said retread band.

23. (canceled)

24. A retread rim assembly according to claim 22, wherein said elastomeric material of said retread band includes a third elastomeric material having a third abrasion-resistance property that is greater than at least said first abrasion-resistance property of said first elastomeric material, said third elastomeric material at least partially defining said outer surface of said retread band.

25.-31. (canceled)

32. A retread band elastically extensible about an associated plurality of retread rim segments, said retread band comprising:
a first layer of elastomeric material extending annularly about a longitudinal axis;
a first annular edge;
a second annular edge spaced longitudinally from said first annular edge;
an inner surface facing radially inward and dimensioned to abuttingly engage the associated plurality of retread rim segments;
an outer surface facing radially outward and dimensioned to abuttingly engage associated beads of an associated tire to be retreaded; and,
at least one reinforcing ply at least partially embedded within said first layer of elastomeric material, said at least one reinforcing ply including a plurality of reinforcing filaments extending annularly about said longitudinal axis within said first layer of elastomeric material such that said plurality of reinforcing filaments are axially spaced apart from one another in an axial direction between said first and second annular edges.

33.-36. (canceled)

37. A retread band according to claim 32, wherein said retread band includes a midplane disposed between said first and second annular edges and oriented transverse to said longitudinal axis, and said at least one reinforcing ply includes a first reinforcing ply with a plurality of reinforcing filaments extending around said longitudinal axis and oriented at a first bias angle relative to said midplane with said first bias angle being within a range of from approximately zero (0) degrees to approximately ten (10) degrees.

38. (canceled)

39. A retread band according to claim 32, wherein said at least one reinforcing ply includes a first reinforcing ply with a first plurality of reinforcing filaments extending around said longitudinal axis and oriented at a first bias angle relative to said midplane with said first bias angle being within a range of from approximately zero (0) degrees to approximately thirty (30) degrees.

40. A retread band according to claim 39, wherein said first bias angle is within a range of from approximately ten (10) degrees to approximately twenty five (25) degrees.

41. A retread band according to claim 39, wherein said at least one reinforcing ply includes a second reinforcing ply disposed radially outward of said first reinforcing ply, said second reinforcing ply including a second plurality of reinforcing filaments extending around said longitudinal axis and oriented at a second bias angle relative to said midplane with said second bias angle being within a range of from approximately zero (0) degrees to approximately thirty (30) degrees.

42. A retread band according to claim 41, wherein said second bias angle is within a range of from approximately ten (10) degrees to approximately twenty five (25) degrees.

43. A retread band according to claim 41, wherein said first bias angle and said second bias angle are approximately equal in magnitude and oriented in opposing directions relative to one another.

44.-54. (canceled)

55. A retread band according to claim 32, wherein said elastomeric material of said first layer includes a first elastomeric material having a first abrasion-resistance property and a second elastomeric material having a second abrasion-resistance property that is greater than said first abrasion-resistance property of said first elastomeric material, said second elastomeric material at least partially defining said inner surface of said retread band.

56. (canceled)

57. A retread band according to claim 55 further comprising a third layer of material at least partially formed from a third elastomeric material having a third abrasion-resistance property that is greater than at least said first abrasion-resistance property of said first elastomeric material, said third elastomeric material at least partially defining said outer surface of said retread band.

58. A retread band according to claim 32, wherein said retread band includes a release layer disposed along said outer surface.

59. A retread band according to claim 32, wherein said retread band has a cross-sectional shape with a base portion and at least one rib portion projecting radially inward from said inner surface toward said inner end of segment body.

60. A retread band elastically extensible about an associated plurality of retread rim segments, said retread band having a longitudinal axis and comprising:
a first annular edge;
a second annular edge spaced longitudinally from said first annular edge
an inner surface facing radially inward and dimensioned to abuttingly engage the associated plurality of retread rim segments;
an outer surface facing radially outward and dimensioned to abuttingly engage associated beads of an associated tire to be retreaded;
a base portion at least partially formed from elastomeric material and extending annularly about said longitudinal axis, said base portion extending between said first and second annular edges such that said base portion has a base portion length between said first and second annular edges;
a rib portion at least partially formed from elastomeric material and disposed along said base portion, said rib portion extending longitudinally between a first rib edge and a second rib edge and having a rib portion length defined therebetween that is less than said base portion length;
a first reinforcing ply at least partially embedded within said base portion, said first reinforcing ply including a first plurality of reinforcing filaments extending annularly about said longitudinal axis within said base portion; and,
a second reinforcing ply at least partially embedded within said rib portion, said second reinforcing ply including a second plurality of reinforcing filaments extending annularly about said longitudinal axis within said rib portion.

61.-87. (canceled)

88. A retread band according to claim 60, wherein said rib portion extends longitudinally between a first rib edge spaced longitudinally inward from said first annular edge and a second rib edge spaced longitudinally inward from said second annular edge.
